(19) United States
(12) Patent Application Publication
(10) Pub. No.: US 2014/0355451 A1
(43) Pub. Date: Dec. 4, 2014

(54) METHOD FOR MONITORING A DOWNLINK CONTROL CHANNEL, AND WIRELESS DEVICE

(71) Applicant: LG ELECTRONICS INC., Seoul (KR)

(72) Inventors: Hak Seong Kim, Anyang-si (KR); Han Byul Seo, Anyang-si (KR); Ki Jun Kim, Anyang-si (KR)

(21) Appl. No.: 14/363,731

(22) PCT Filed: Dec. 7, 2012
(86) PCT No.: PCT/KR2012/010651

§ 371 Date: Jun. 6, 2014

Related U.S. Application Data
(60) Provisional application No. 61/568,147, filed on Dec. 7, 2011.
(60) Provisional application No. 61/650,445, filed on May 22, 2012.

(51) Int. Cl. H04W 24/08; H04L 1/18; H04L 5/00; H04L 1/16

(52) U.S. Cl. CPC H04W 24/08; H04L 1/1671; H04L 1/1812; H04L 5/0055
USPC 370/241

(57) ABSTRACT

Provided are a method for monitoring a control channel in a wireless communication system, and a wireless device. The wireless device receives a group identifier from a base station, and monitors a downlink control channel in a search space including N (N>=1) enhanced control channel elements (ECCEs) in accordance with the group identifier.

### BACKGROUND OF THE INVENTION

1. Field of the invention

The present invention relates to wireless communications, and more particularly, to a method for monitoring a downlink control channel in a wireless communication system, and a wireless device using the method.

2. Related Art

Long term evolution (LTE) based on 3^{rd} generation partnership project (3GPP) technical specification (TS) release 8 is a promising next-generation mobile communication standard. Recently, LTE-advanced (LTE-A) based on 3GPP TS release 10 supporting multiple carriers is under standardization.

As disclosed in 3GPP TS 36.211 V10.2.0 (2011-06) “Evolved Universal Terrestrial Radio Access (E-UTRA); Physical Channels and Modulation (Release 10)”, a physical channel of 3GPP LTE/LTE-A can be classified into a downlink channel, i.e., a physical downlink shared channel (PDSCH) and a physical downlink control channel (PDCCH), and an uplink channel, i.e., a physical uplink shared channel (PUSCFI) and a physical uplink control channel (PUCCH).

To cope with increasing data traffic, various techniques are introduced to increase transmission capacity of a mobile communication system. For example, a multiple input multiple output (MIMO) technique using multiple antennas, a carrier aggregation technique supporting multiple cells, etc., are introduced.

The PDCCH designed in 3GPP LTE/LTE-A carries a variety of control information. The introduction of a new technology requires to increase capacity of the control channel and to improve scheduling flexibility.

### SUMMARY OF THE INVENTION

The present invention provides a method of monitoring a downlink control channel, and a wireless device using the method.

In an aspect, a method for monitoring a control channel in a wireless communication system is provided. The method includes receiving, by a wireless device, a group identifier from a base station, and monitoring, by the wireless device, a downlink control channel in a search space including N (N>=1) enhanced control channel elements (ECCEs) in accordance with the group identifier. The downlink control channel includes positive-acknowledgement (ACK)/negative-acknowledgement (NACK) information having hybrid automatic repeat request (HARQ) ACK/NACK for at least one wireless device.

The N ECCEs may be defined in one or more physical resource block (PRB) pairs.

In another aspect, a wireless device for monitoring a control channel in a wireless communication system is provided. The wireless device includes a radio frequency (RF) unit configured to transmit and receive a radio signal, and a processor operatively coupled to the RF unit and configured to receive a group identifier from a base station and monitor a downlink control channel in a search space including N(N>=1) enhanced control channel elements (ECCEs) in accordance with the group identifier.

A base station can multiplex multiple downlink control channels in a search space, and a wireless device can monitor the multiple downlink control channels.

### BRIEF DESCRIPTION OF THE DRAWINGS

FIG. 1 shows a structure of a downlink (DL) radio frame in 3^{rd} generation partnership project (3GPP) long term evolution-advanced (LTE-A).

FIG. 2 is a block diagram showing a structure of a physical downlink control channel (PDCCH).

FIG. 3 shows an example of monitoring a PDCCH.

FIG. 4 shows uplink (UL) synchronous hybrid automatic repeat request (HARQ) in 3GPP LTE.

FIG. 5 shows a structure of a physical hybrid-ARQ indicator channel (PHICH) in 3GPP LTE.

FIG. 6 shows an example of arranging a reference signal and a control channel in a DL subframe of 3GPP LTE.

FIG. 7 is an example of a subframe having an enhanced PDCCH (EPDCCH).

FIG. 8 shows an example of a subframe having an EPHICH according to an embodiment of the present invention.

FIG. 9 shows an example of a physical resource block (PRB) pair.

FIG. 10 shows an example of a PRB pair to which a cyclic shift is applied.

FIG. 11 shows control channel mapping according to an embodiment of the present invention.

FIG. 12 shows an example of mapping an EPHICH to an orthogonal frequency-division multiplexing (OFDM) symbol in which a demodulation reference signal (DM RS) exists.

FIG. 13 shows an example in which a CRS and a CRI-RS are added in the mapping of FIG. 12.

FIG. 14 shows an example of mapping a DM RS and a CSI-RS.

FIG. 15 shows an example of mapping an EPHICH to an OFDM symbol in which a DM RS does not exist.

FIG. 16 shows an example in which a CRS is added in the mapping of FIG. 15.

FIG. 17 shows an example in which three transmission schemes coexist.

FIG. 18 shows a power loss caused by a DM RS.

FIG. 19 shows an example of spreading a control channel for a DM RS which uses 2 antenna ports.

FIG. 20 and FIG. 21 show an example of spreading a control channel for a DM RS which uses 4 antenna ports.

FIG. 22, FIG. 23, and FIG. 24 show another example of spreading a control channel for a DM RS.

FIG. 25 shows control channel monitoring according to an embodiment of the present invention.

FIG. 26 is a block diagram showing a wireless communication system according to an embodiment of the present invention.

### DESCRIPTION OF EXEMPLARY EMBODIMENTS

A wireless device may be fixed or mobile, and may be referred to as another terminology, such as a user equipment (UE), a mobile station (MS), a mobile terminal (MT), a user terminal (UT), a subscriber station (SS), a personal digital assistant (PDA), a wireless modem, a handheld device, etc. The wireless device may also be a device supporting only data communication such as a machine-type communication (MTC) device.

A base station (BS) is generally a fixed station that communicates with the wireless device, and may be referred to as another terminology, such as an evolved-NodeB (eNB), a base transceiver system (BTS), an access point, etc.

Hereinafter, it is described that the present invention is applied according to a 3rd generation partnership project (3GPP) long term evolution (LTE) based on 3GPP technical specification (TS) release 8 or 3GPP LTE-advanced (LTE-A) based on 3GPP TS release 10. However, this is for exemplary purposes only, and thus the present invention is also applicable to various wireless communication networks. In the following description, LTE and/or LTE-A are collectively referred to as LTE.

The wireless device may be served by a plurality of serving cells. Each serving cell may be defined with a downlink (DL) component carrier (CC) or a pair of a DL CC and an uplink (UL) CC.

The serving cell may be classified into a primary cell and a secondary cell. The primary cell operates at a primary frequency, and is a cell designated as the primary cell when an initial network entry process is performed or when a network re-entry process starts or in a handover process. The primary cell is also called a reference cell. The secondary cell operates at a secondary frequency. The secondary cell may be configured after an RRC connection is established, and may be used to provide an additional radio resource. At least one primary cell is configured always. The secondary cell may be added/modified/released by using higher-layer signaling (e.g., a radio resource control (RRC) message).

A cell index (CI) of the primary cell may be fixed. For example, a lowest CI may be designated as the CI of the primary cell. It is assumed hereinafter that the CI of the primary cell is 0 and a CI of the secondary cell is allocated sequentially starting from 1.

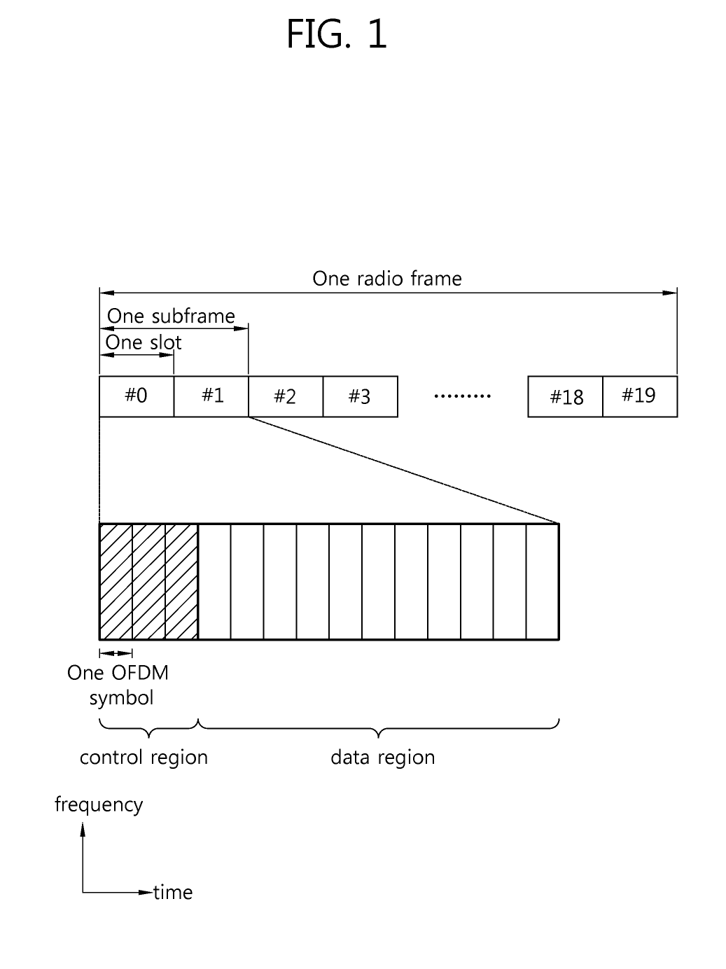

FIG. 1 shows a structure of a DL radio frame in 3GPP LTE-A. The section 6 of 3GPP TS 36.211 V10.2.0 (2011-06) “Evolved Universal Terrestrial Radio Access (E-UTRA); Physical Channels and Modulation (Release 10)” may be incorporated herein by reference.

A radio frame includes 10 subframes indexed with 0 to 9. One subframe includes 2 consecutive slots. A time required for transmitting one subframe is defined as a transmission time interval (TTI). For example, one subframe may have a length of 1 millisecond (ms), and one slot may have a length of 0.5 ms.

One slot may include a plurality of orthogonal frequency division multiplexing (OFDM) symbols in a time domain. Since the 3GPP LTE uses orthogonal frequency division multiple access (OFDMA) in a downlink (DL), the OFDM symbol is only for expressing one symbol period in the time domain, and there is no limitation in multiple access schemes or terminologies. For example, the OFDM symbol may also be referred to as another terminology such as a single carrier frequency division multiple access (SC-FDMA) symbol, a symbol period, etc.

Although it is described that one slot includes 7 OFDM symbols for example, the number of OFDM symbols included in one slot may vary depending on a length of a cyclic prefix (CP). According to 3GPP TS 36.211 V10.2.0, in case of a normal CP, one slot includes 7 OFDM symbols, and in case of an extended CP, one slot includes 6 OFDM symbols.

A resource block (RB) is a resource allocation unit, and includes a plurality of subcarriers in one slot. For example, if one slot includes 7 OFDM symbols in a time domain and the RB includes 12 subcarriers in a frequency domain, one RB can include 7□12 resource elements (REs).

A DL subframe is divided into a control region and a data region in the time domain. The control region includes up to first four OFDM symbols of a first slot in the subframe. However, the number of OFDM symbols included in the control region may vary. A physical downlink control channel (PDCCH) and other control channels are allocated to the control region, and a physical downlink shared channel (PDSCH) is allocated to the data region.

As disclosed in 3GPP TS 36.211 V10.2.0, examples of a physical control channel in 3GPP LTE/LTE-A include a physical downlink control channel (PDCCH), a physical control format indicator channel (PCFICH), and a physical hybrid-ARQ indicator channel (PHICH).

The PCFICH transmitted in a first OFDM symbol of the subframe carries a control format indicator (CFI) regarding the number of OFDM symbols (i.e., a size of the control region) used for transmission of control channels in the subframe. A wireless device first receives the CFI on the PCFICH, and thereafter monitors the PDCCH.

Unlike the PDCCH, the PCFICH does not use blind decoding, and is transmitted by using a fixed PCFICH resource of the subframe.

The PHICH carries a positive-acknowledgement (ACK)/negative-acknowledgement (NACK) signal for an uplink hybrid automatic repeat request (HARQ). The ACK/NACK signal for uplink (UL) data on a PUSCH transmitted by the wireless device is transmitted on the PHICH.

A physical broadcast channel (PBCH) is transmitted in first four OFDM symbols in a second slot of a first subframe of a radio frame. The PBCH carries system information necessary for communication between the wireless device and a BS. The system information transmitted through the PBCH is referred to as a master information block (MIB). In comparison thereto, system information transmitted on the PDCCH is referred to as a system information block (SIB).

Control information transmitted through the PDCCH is referred to as downlink control information (DCI). The DCI may include resource allocation of the PDSCH (this is referred to as a downlink (DL) grant), resource allocation of a PUSCH (this is referred to as an uplink (UL) grant), a set of transmit power control commands for individual UEs in any UE group, and/or activation of a voice over Internet protocol (VoIP).

In 3GPP LTE/LTE-A, transmission of a DL transport block is performed in a pair of the PDCCH and the PDSCH. Transmission of a UL transport block is performed in a pair of the PDCCH and the PUSCH. For example, the wireless device receives the DL transport block on a PDSCH indicated by the PDCCH. The wireless device receives a DL resource assignment on the PDCCH by monitoring the PDCCH in a DL subframe. The wireless device receives the DL transport block on a PDSCH indicated by the DL resource assignment.

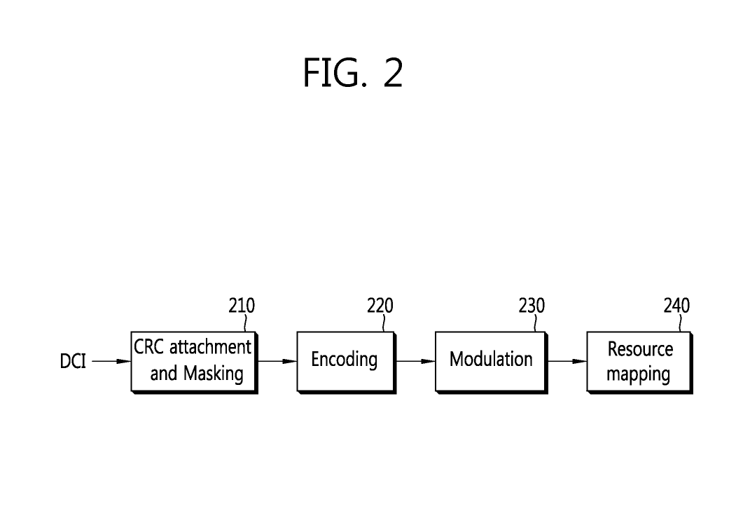

FIG. 2 is a block diagram showing a structure of a PDCCH.

The 3GPP LTE/LTE-A uses blind decoding for PDCCH detection. The blind decoding is a scheme in which a desired identifier is de-masked from a cyclic redundancy check (CRC) of a received PDCCH (referred to as a candidate PDCCH) to determine whether the PDCCH is its own control channel by performing CRC error checking.

A BS determines a PDCCH format according to DCI to be transmitted to a wireless device, attaches a CRC to control information, and masks a unique identifier (referred to as a radio network temporary identifier (RNTI)) to the CRC according to an owner or usage of the PDCCH (block 210).

If the PDCCH is for a specific wireless device, a unique identifier (e.g., cell-RNTI (C-RNTI)) of the wireless device may be masked to the CRC. Alternatively, if the PDCCH is for a paging message, a paging indication identifier (e.g., paging-RNTI (P-RNTI)) may be masked to the CRC. If the PDCCH is for system information, a system information identifier (e.g., system information-RNTI (SI-RNTI)) may be masked to the CRC. To indicate a random access response that is a response for transmission of a random access preamble of the wireless device, a random access-RNTI (RA-RNTI) may be masked to the CRC. To indicate a transmit power control (TPC) command for a plurality of wireless devices, a TPC-RNTI may be masked to the CRC.

When the C-RNTI is used, the PDCCH carries control information for a specific wireless device (such information is called UE-specific control information), and when other RNTIs are used, the PDCCH carries common control information received by all or a plurality of wireless devices in a cell.

The CRC-attached DCI is encoded to generate coded data (block 220). Encoding includes channel encoding and rate matching.

The coded data is modulated to generate modulation symbols (block 230).

The modulation symbols are mapped to physical resource elements (REs) (block 240). The modulation symbols are respectively mapped to the REs.

A control region in a subframe includes a plurality of control channel elements (CCEs). The CCE is a logical allocation unit used to provide the PDCCH with a coding rate depending on a radio channel state, and corresponds to a plurality of resource element groups (REGs). The REG includes a plurality of REs. According to an association relation of the number of CCEs and the coding rate provided by the CCEs, a PDCCH format and a possible number of bits of the PDCCH are determined.

One REG includes 4 REs. One CCE includes 9 REGs. The number of CCEs used to configure one PDCCH may be selected from a set {1, 2, 4, 8}. Each element of the set {1, 2, 4, 8} is referred to as a CCE aggregation level.

The BS determines the number of CCEs used in transmission of the PDCCH according to a channel state. For example, a wireless device having a good DL channel state can use one CCE in PDCCH transmission. A wireless device having a poor DL channel state can use 8 CCEs in PDCCH transmission.

A control channel consisting of one or more CCEs performs interleaving on an REG basis, and is mapped to a physical resource after performing cyclic shift based on a cell identifier (ID).

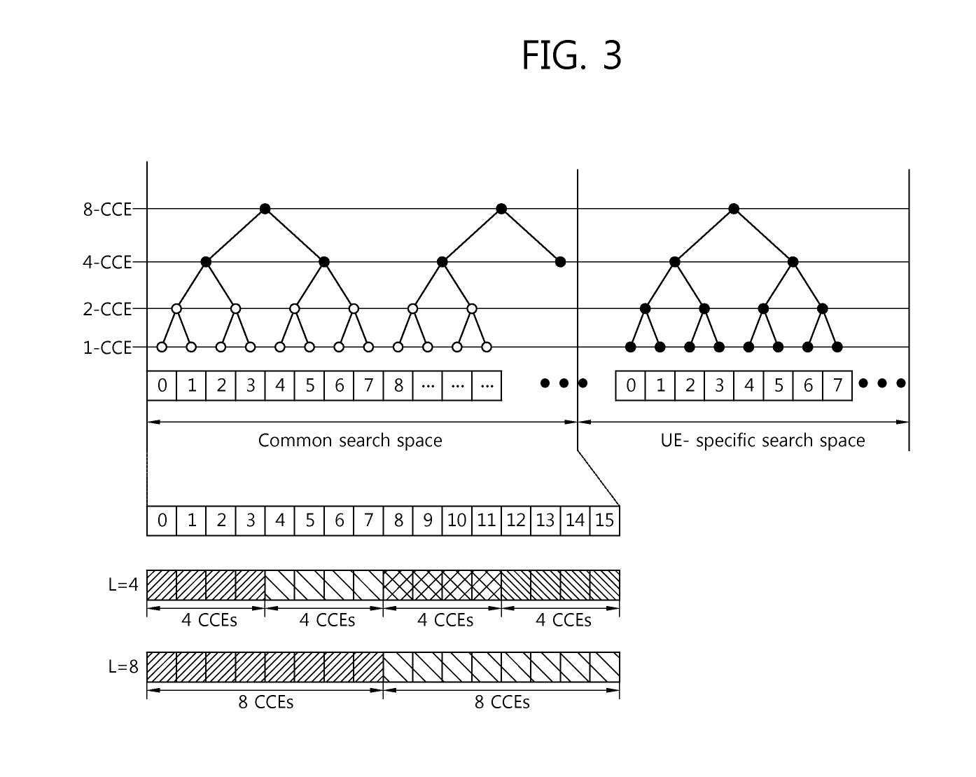

FIG. 3 shows an example of monitoring a PDCCH. The section 9 of 3GPP TS 36.213 V10.2.0 (2011-06) can be incorporated herein by reference.

The 3GPP LTE uses blind decoding for PDCCH detection. The blind decoding is a scheme in which a desired identifier is de-masked from a CRC of a received PDCCH (referred to as a candidate PDCCH) to determine whether the PDCCH is its own control channel by performing CRC error checking. A wireless device cannot know about a specific position in a control region in which its PDCCH is transmitted and about a specific CCE aggregation or DCI format used for PDCCH transmission.

A plurality of PDCCHs can be transmitted in one subframe. The wireless device monitors the plurality of PDCCHs in every subframe. Monitoring is an operation of attempting PDCCH decoding by the wireless device according to a format of the monitored PDCCH.

The 3GPP LTE uses a search space to reduce a load of blind decoding. The search space can also be called a monitoring set of a CCE for the PDCCH. The wireless device monitors the PDCCH in the search space.

The search space is classified into a common search space and a UE-specific search space. The common search space is a space for searching for a PDCCH having common control information and consists of 16 CCEs indexed with 0 to 15. The common search space supports a PDCCH having a CCE aggregation level of {4, 8}. However, a PDCCH (e.g., DCI formats 0, 1A) for carrying UE-specific information can also be transmitted in the common search space. The UE-specific search space supports a PDCCH having a CCE aggregation level of {1, 2, 4, 8}.

Table 1 shows the number of PDCCH candidates monitored by the wireless device.

TABLE 1

| | | | Number of | |
|---|---|---|---|---|
| Search Space | Aggregation | Size | PDCCH | |
| Type | level L | [In CCEs] | candidates | DCI formats |
| UE-specific | 1 | 6 | 6 | 0, 1, 1A, 1B, |
| | 2 | 12 | 6 | 1D, 2, 2A |
| | 4 | 8 | 2 | |
| | 8 | 16 | 2 | |
| Common | 4 | 16 | 4 | 0, 1A, 1C, 3/3A |
| | 8 | 16 | 2 | |

A size of the search space is determined by Table 1 above, and a start point of the search space is defined differently in the common search space and the UE-specific search space. Although a start point of the common search space is fixed irrespective of a subframe, a start point of the UE-specific search space may vary in every subframe according to a UE identifier (e.g., C-RNTI), a CCE aggregation level, and/or a slot number in a radio frame. If the start point of the UE-specific search space exists in the common search space, the UE-specific search space and the common search space may overlap with each other.

In a CCE aggregation level L∈{1,2,3,4}, a search space S^{(L)}ₖ is defined as a set of PDCCH candidates. A CCE corresponding to a PDCCH candidate m of the search space S^{(L)}ₖ is given by Equation 1 below.

L·{(Yₖ+m′)mod └N_{CCE,k}/L┘}+i [Equation 1]

Herein, i=0, 1, . . . , L-1, m=0, . . . , M^{(L)-}1 and N_{CCE,k} denotes the total number of CCEs that can be used for PDCCH transmission in a control region of a subframe k. The control region includes a set of CCEs numbered from 0 to N_{CCE,k-1}. M^{(L)} denotes the number of PDCCH candidates in a CCE aggregation level L of a given search space.

If a carrier indicator field (CIF) is set to the wireless device, m′=m+M^{(L)n}_{cif}. Herein, n_{cif} is a value of the CIF. If the CIF is not set to the wireless device, m′=m.

In a common search space, Yₖ is set to 0 with respect to two aggregation levels L=4 and L=8.

In a UE-specific search space of the aggregation level L, a variable Yₖ is defined by Equation 2 below.

Yₖ=(A·Yₖ₋₁) mod D [Equation 2]

Herein, Y₋₁=n_{RNTI}≠0, A=39827, D=65537, k=floor(nₛ/2), and nₛ denotes a slot number in a radio frame.

When the wireless device monitors the PDCCH by using the C-RNTI, a search space and a DCI format used in monitoring are determined according to a transmission mode of the PDSCH. Table 2 below shows an example of PDCCH monitoring in which the C-RNTI is set.

TABLE 2

| Trans- | | | |
|---|---|---|---|
| mission | | | Transmission mode of |
| mode | DCI format | search space | PDSCH based on PDCCH |
| Mode 1 | DCI format 1A | common and | Single antenna port, |
| | | UE specific | port 0 |
| | DCI format 1 | UE specific | Single antenna port, |
| | | | port 0 |
| Mode 2 | DCI format 1A | common and | Transmit diversity |
| | | UE specific | |
| | DCI format 1 | UE specific | Transmit diversity |
| Mode 3 | DCI format 1A | common and | Transmit diversity |
| | | UE specific | |
| | DCI format 2A | UE specific | CDD(Cyclic Delay |
| | | | Diversity) or Transmit |
| | | | diversity |
| Mode 4 | DCI format 1A | common and | Transmit diversity |
| | | UE specific | |
| | DCI format 2 | UE specific | Closed-loop spatial |
| | | | multiplexing |
| Mode 5 | DCI format 1A | common and | Transmit diversity |
| | | UE specific | |
| | DCI format 1D | UE specific | MU-MIMO(Multi-user |
| | | | Multiple Input Multiple |
| | | | Output) |
| Mode 6 | DCI format 1A | common and | Transmit diversity |
| | | UE specific | |
| | DCI format 1B | UE specific | Closed-loop spatial |
| | | | multiplexing |
| Mode 7 | DCI format 1A | common and | If the number of PBCH |
| | | UE specific | transmission ports is 1, |
| | | | single antenna port, port 0, |
| | | | otherwise Transmit diversity |
| | DCI format 1 | UE specific | Single antenna port, port 5 |
| Mode 8 | DCI format 1A | common and | If the number of PBCH |
| | | UE specific | transmission ports is 1, |
| | | | single antenna port, port 0, |
| | | | otherwise, Transmit diversity |
| | DCI format 2B | UE specific | Dual layer transmission |
| | | | (port 7 or 8), or single |
| | | | antenna port, port 7 or 8 |

The usage of the DCI format is classified as shown in Table 3 below.

TABLE 3

| DCI format | Contents |
|---|---|
| DCI format 0 | It is used for PUSCH scheduling. |
| DCI format 1 | It is used for scheduling of one PDSCH codeword. |
| DCI format 1A | It is used for compact scheduling and random access |
| | process of one PDSCH codeword. |
| DCI format 1B | It is used in simple scheduling of one PDSCH codeword |
| | having precoding information. |
| DCI format 1C | It is used for very compact scheduling of one PDSCH |
| | codeword. |
| DCI format 1D | It is used for simple scheduling of one PDSCH codeword |
| | having precoding and power offset information. |
| DCI format 2 | It is used for PDSCH scheduling of UEs configured to a |
| | closed-loop spatial multiplexing mode. |
| DCI format 2A | It is used for PDSCH scheduling of UEs configured to an |
| | open-loop spatial multiplexing mode. |
| DCI format 3 | It is used for transmission of a TPC command of a |
| | PUCCH and a PUSCH having a 2-bit power adjustment. |
| DCI format 3A | It is used for transmission of a TPC command of a |
| | PUCCH and a PUSCH having a 1-bit power adjustment. |

Now, HARQ in 3GPP LTE will be described.

The 3GPP LTE uses synchronous HARQ in UL transmission, and uses asynchronous HARQ in DL transmission. In the synchronous HARQ, retransmission timing is fixed. In the asynchronous HARQ, the retransmission timing is not fixed. That is, in the synchronous HARQ, initial transmission and retransmission are performed with an HARQ period.

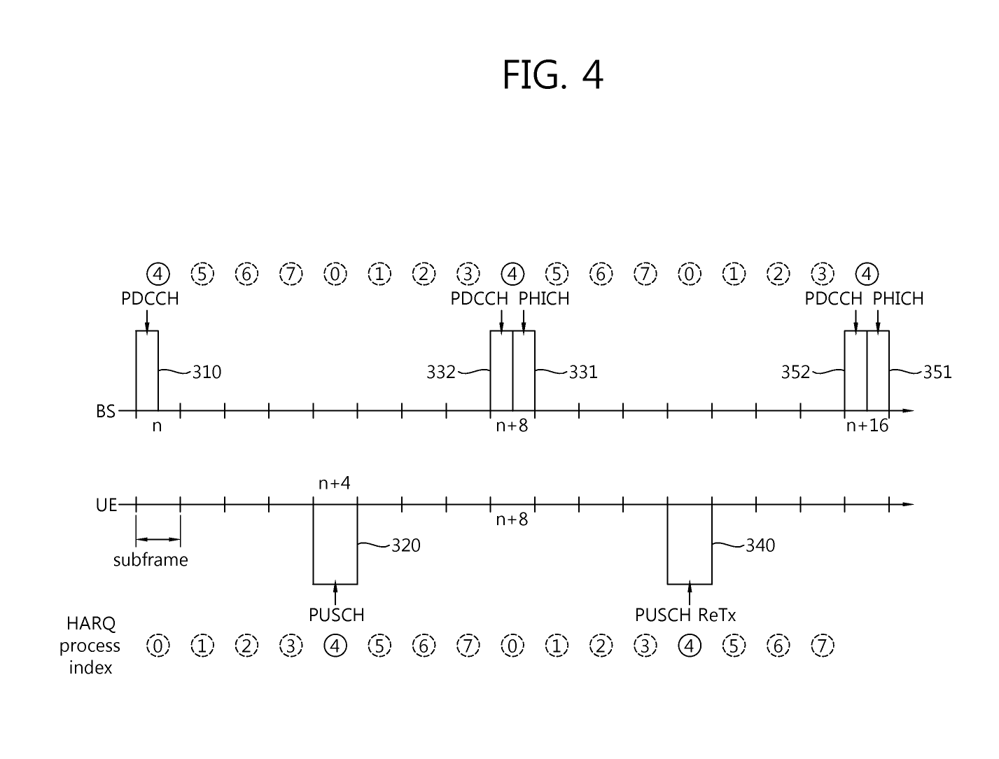

FIG. 4 shows UL synchronous HARQ in 3GPP LTE.

A wireless device receives an initial UL grant on a PDCCH 310 from a BS in an n^{th} subframe.

The wireless device transmits a UL transport block on a PUSCH 320 by using the initial UL grant in an (n+4)^{th} subframe.

The BS sends an ACK/NACK signal for the UL transport block on a PHICH 331 in an (n+8)^{th} subframe. The ACK/NACK signal indicates a reception acknowledgement for the UL transport block. The ACK signal indicates a reception success, and the NACK signal indicates a reception failure. When the ACK/NACK signal is the NACK signal, the BS may send a retransmission UL grant on a PDCCH 332, or may not send an additional UL grant.

Upon receiving the NACK signal, the wireless device sends a retransmission block on a PUSCH 340 in an (n+12)^{th} subframe. To transmit the retransmission block, if the retransmission UL grant is received on the PDCCH 332, the wireless device uses the retransmission UL grant, and if the retransmission UL grant is not received, the wireless device uses the initial UL grant.

The BS sends an ACK/NACK signal for the UL transport block on a PHICH 351 in an (n+16)^{th} subframe. When the ACK/NACK signal is the NACK signal, the BS may send a retransmission UL grant on a PDCCH 352, or may not send an additional UL grant.

After initial transmission is performed in the (n+4)^{th} subframe, retransmission is performed in the (n+12)^{th} subframe, and thus synchronous HARQ is performed with an HARQ period corresponding to 8 subframes.

Therefore, in frequency division duplex (FDD) of 3GPP LTE, 8 HARQ processes can be performed, and the respective HARQ processes are indexed from 0 to 7.

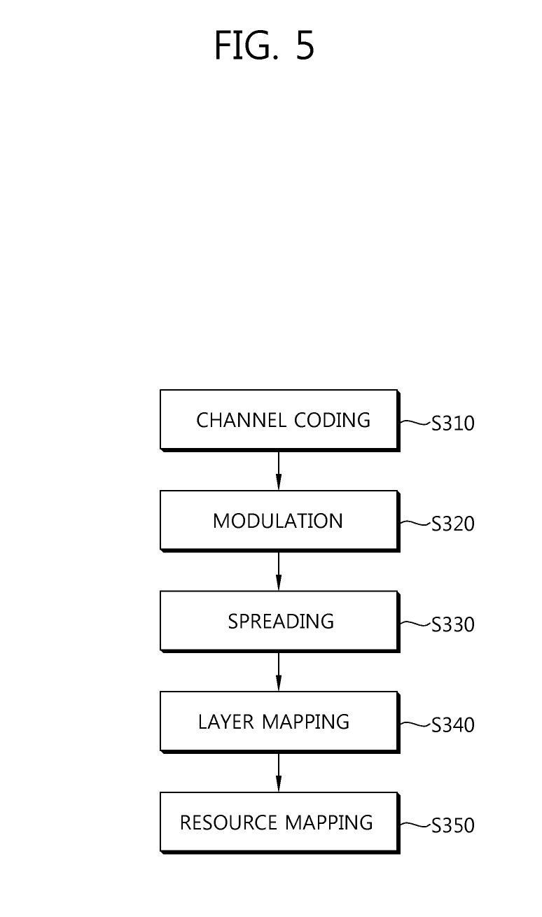

FIG. 5 shows a structure of a PHICH in 3GPP LTE.

One PHICH carries only 1-bit ACK/NACK corresponding to a PUSCH for one UE, that is, corresponding to a single stream.

In step S310, the 1-bit ACK/NACK is coded into 3 bits by using a repetition code having a code rate of 1/3.

In step S320, the coded ACK/NACK is modulated using binary phase shift keying (BPSK) to generate 3 modulation symbols.

In step S330, the modulation symbols are spread by using an orthogonal sequence. A spreading factor (SF) is N^{PHICH}_{SF}=4 in a normal CP case, and is N^{PHICH}_{SF}=2 in an extended CP case. The number of orthogonal sequences used in the spreading is N^{PHICH}_{SF}*2 to apply I/Q multiplexing. PHICHs which are spread by using N^{PHICH}_{SF}*2 orthogonal sequences can be defined as one PHICH group.

Table 4 below shows an orthogonal sequence for the PHICH.

TABLE 4

orthogonal sequence

| sequence index | normal CP | extended CP |
|---|---|---|
| n^{seq}_{PHICH} | (N^{PHICH}_{SF} = 4) | (N^{PHICH}_{SF} = 2) |
| 0 | [+1 +1 +1 +1] | [+1 +1] |
| 1 | [+1 −1 +1 −1] | [+1 −1] |
| 2 | [+1 +1 −1 −1] | [+j +j] |
| 3 | [+1 −1 −1 +1] | [+j −j] |
| 4 | [+j +j +j +j] | |
| 5 | [+j −j +j −j] | |
| 6 | [+j +j −j −j] | |
| 7 | [+j −j −j +j] | |

In step S340, layer mapping is performed on the spread symbols.

In step S350, the layer-mapped symbols are transmitted by being mapped to resources.

A plurality of PHICHs mapped to resource elements of the same set constitute a PHICH group. Each PHICH included in the PHICH group is identified by a different orthogonal sequence. In the FDD system, N^{group}_{PHICH}, i.e., the number of PHICH groups, is constant in all subframes, and can be determined by Equation 3 below.

$${N}_{PHICH}^{group} = \{ \begin{matrix}ceil ( {N}_{g} ( {N}_{RB}^{DL} / 8 ) ) & for normal CP \\ 2 ceil ( {N}_{g} ( {N}_{RB}^{DL} / 8 ) ) & for extended CP\end{matrix} \qquad [ Equation 3 ]$$

Herein, Ng denotes a parameter transmitted through a physical broadcast channel (PBCH), where Ng∈{1/6,1/2,1,2}. N^{DL}_{RB} denotes the number of DL RBs.

ceil(x) is a function for outputting a minimum value among integers equal to or greater than x. floor(x) is a function for outputting a maximum value among integers equal to or less than x.

The wireless device identifies a PHICH resource by using an index pair (n^{group}_{PHICH}, n^{seq}_{PHICH}) used by the PHICH. A PHICH group index n_{group}_{PHICH} has a value in the range of 0 to N_{group}_{PHICH}-1. An orthogonal sequence index n^{seq}_{PHICH} denotes an index of an orthogonal sequence.

An index pair (n^{group}_{PHICH}, n^{seq}_{PHICH}) is obtained according to Equation 1 below.

n^{group}_{PHICH}=(I_{PRB}_{_{—}}_{RA}^{lowest}^{_{—}}^{index}+n_{DMRS})modN^{group}_{PHICH}+I_{PHICH}N^{group}_{PHICH}

n^{seq}_{PHICH}=(floor(I_{PRB—}_{RA}^{Lowest}^{_{—}}^{index}/N^{group}_{PHICH})+n_{DMRS})mod2N_{SF}^{PHICH} [Equation 4]

Herein, n_{DMRS} denotes a cyclic shift of a demodulation reference signal (DMRS) within the most recent UL grant for a transport block related to corresponding PUSCH transmission. The DMRS is an RS used for PUSCH transmission. N^{PHICH}_{SF} denotes an SF size of an orthogonal sequence used in PHICH modulation. I^{lowest}^{_{—}}^{index}_{PRB}_{_{—}}_{RA} denotes the smallest PRB index in a 1^{st} slot of corresponding PUSCH transmission. I_{PHICH} is 0 or 1.

A physical resource block (PRB) is a unit frequency-time resource for transmitting data. One PRB consists of a plurality of contiguous REs in a frequency-time domain. Hereinafter, the RB and the PRB are used for the same concept.

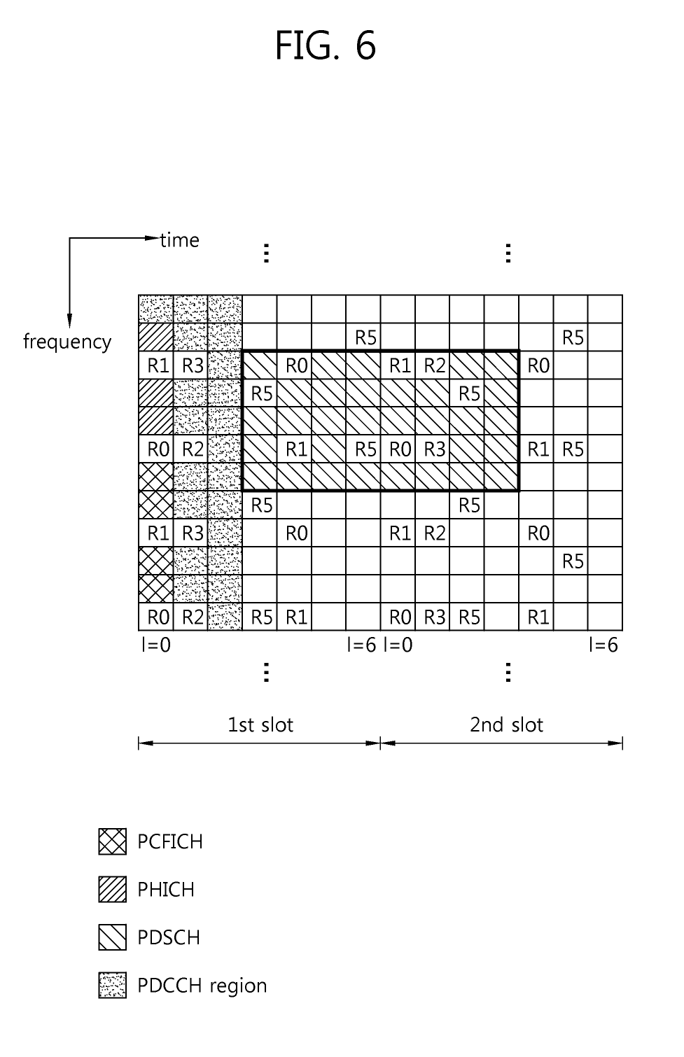

FIG. 6 shows an example of arranging a reference signal and a control channel in a DL subframe of 3GPP LTE.

A control region (or a PDCCH region) includes first three OFDM symbols, and a data region in which a PDSCH is transmitted includes the remaining OFDM symbols.

A PCFICH, a PHICH, and/or a PDCCH are transmitted in the control region. A control format indictor (CFI) of the PCFICH indicates three OFDM symbols. A region excluding a resource in which the PCFICH and/or the PHICH are transmitted in the control region is a PDCCH region which monitors the PDCCH.

Various reference signals are transmitted in the subframe.

A cell-specific reference signal (CRS) may be received by all wireless devices in a cell, and is transmitted across a full downlink frequency band. In FIG. 4, ‘R0’ indicates a resource element (RE) used to transmit a CRS for a first antenna port, ‘R1’ indicates an RE used to transmit a CRS for a second antenna port, ‘R2’ indicates an RE used to transmit a CRS for a third antenna port, and ‘R3’ indicates an RE used to transmit a CRS for a fourth antenna port.

An RS sequence r_{l,ns}(m) for a CRS is defined as follows.

$${r}_{l , ns} ( m ) = \frac{1}{\sqrt{2 }} ( 1 - 2 \cdot c ( 2 m ) ) + j \frac{1}{\sqrt{2}} ( 1 - 2 \cdot c ( 2 m + 1 ) ) \qquad [ Equation 3 ]$$

Herein, m=0, 1, . . . , 2N_{maxRB}-1. N_{maxRB} is the maximum number of RBs. ns is a slot number in a radio frame. l is an OFDM symbol index in a slot.

A pseudo-random sequence c(i) is defined by a length-31 gold sequence as follows.

c(n)=(x₁(n+Nc)+x₂(n+Nc)) mod 2

x₁(n+31)=(x₁(n+3)+x₁(n)) mod 2

x₂(n+31)=(x₂(n+3)+x₂(n+2)+x₂(n+1)+x₂(n)) mod 2 [Equation 4]

Herein, Nc=1600, and a first m-sequence is initialized as x₁(0)=1, x₁(n)=0, m=1,2, . . . ,30.

A second m-sequence is initialized as cᵢₙᵢₜ=2¹⁰(7(ns+1)+1+1)(2N^{cell}_{ID}+1)+2N^{cell}_{ID}+N_{CP} at a start of each OFDM symbol. N^{cell}_{ID} is a physical cell identifier (PCI). N_{CP}=1 in a normal CP case, and N_{CP}=0 in an extended CP case.

A UE-specific reference signal (URS) is transmitted in the subframe. Whereas the CRS is transmitted in the entire region of the subframe, the URS is transmitted in a data region of the subframe and is used to demodulate the PDSCH. In FIG. 4, ‘R5’ indicates an RE used to transmit the URS. The URS is also called a dedicated reference signal (DRS) or a demodulation reference signal (DM-RS).

The URS is transmitted only in an RB to which a corresponding PDSCH is mapped. Although R5 is indicated in FIG. 4 in addition to a region in which the PDSCH is transmitted, this is for indicating a location of an RE to which the URS is mapped.

The URS is used only by a wireless device which receives a corresponding PDSCH. A reference signal (RS) sequence rₙₛ(m) for the URS is equivalent to Equation 3. In this case, m=0,1, . . . ,12N_{PDSCH,RB}-1, and N_{PDSCH,RB} is the number of RBs used for transmission of a corresponding PDSCH. A pseudo-random sequence generator is initialized as cᵢₙᵢₜ=(floor(ns/2)+1)(2 N^{cell}_{ID}+1)2¹⁶+n_{RNTI} at a start of each subframe. n_{RNTI} is an identifier of the wireless device.

The aforementioned initialization method is for a case where the URS is transmitted through the single antenna, and when the URS is transmitted through multiple antennas, the pseudo-random sequence generator is initialized as cᵢₙᵢₜ=(floor(ns/2)+1)(2N^{cell}_{ID}+1)2¹⁶+n_{SCID} at a start of each subframe. n_{SCID} is a parameter acquired from a DL grant (e.g., a DCI format 2B or 2C) related to PDSCH transmission.

The URS supports multiple input multiple output (MIMO) transmission. According to an antenna port or a layer, an RS sequence for the URS may be spread into a spread sequence as follows.

TABLE 5

| Layer | [w(0) w(1) w(2) w(3)] |
|---|---|
| 1 | [+1 +1 +1 +1] |
| 2 | [+1 −1 +1 −1] |
| 3 | [+1 +1 +1 +1] |
| 4 | [+1 −1 +1 −1] |
| 5 | [+1 +1 −1 −1] |
| 6 | [−1 −1 +1 +1] |
| 7 | [+1 −1 −1 +1] |
| 8 | [−1 +1 +1 −1] |

A layer may be defined as an information path which is input to a precoder. A rank is a non-zero eigenvalue of a MIMO channel matrix, and is equal to the number of layers or the number of spatial streams. The layer may correspond to an antenna port for identifying a URS and/or a spread sequence applied to the URS.

Meanwhile, the PDCCH is monitored in an area restricted to the control region in the subframe, and a CRS transmitted in a full band is used to demodulate the PDCCH. As a type of control data is diversified and an amount of control data is increased, scheduling flexibility is decreased when using only the existing PDCCH. In addition, in order to decrease an overhead caused by CRS transmission, an enhanced PDCCH (EPDCCH) is introduced.

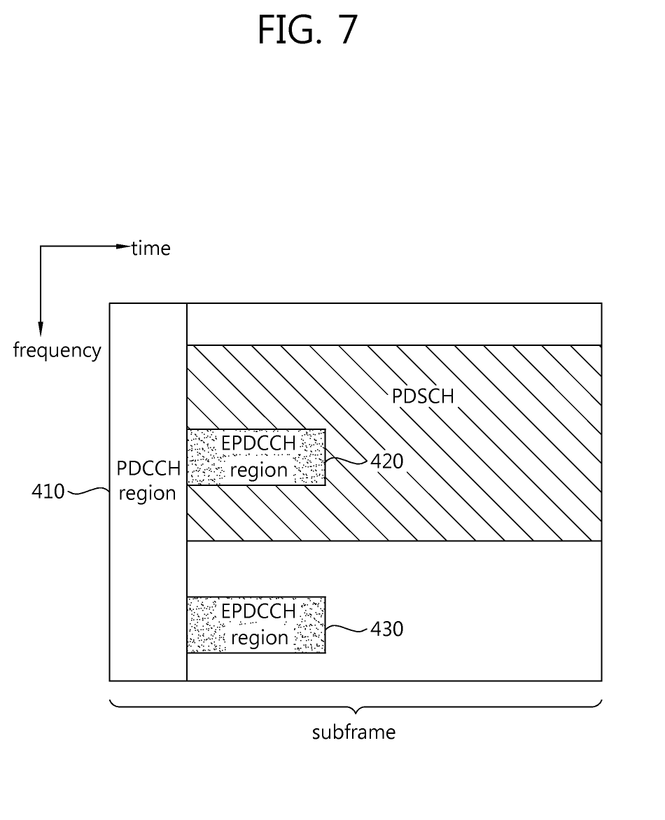

FIG. 7 is an example of a subframe having an EPDCCH.

The subframe may include zero or one PDCCH region 410 and zero or more EPDCCH regions 420 and 430.

The EPDCCH regions 420 and 430 are regions in which a wireless device monitors the EPDCCH. The PDCCH region 410 is located in up to first four OFDM symbols of the subframe, whereas the EPDCCH regions 420 and 430 may be flexibly scheduled in an OFDM symbol located after the PDCCH region 410.

One or more EPDCCH regions 420 and 430 may be assigned to the wireless device. The wireless device may monitor EPDDCH data in the assigned EPDCCH regions 420 and 430.

The number/location/size of the EPDCCH regions 420 and 430 and/or information regarding a subframe for monitoring the EPDCCH may be reported by a BS to the wireless device by using a radio resource control (RRC) message or the like.

In the PDCCH region 410, a PDCCH may be demodulated on the basis of a CRS. In the EPDCCH regions 420 and 430, instead of the CRS, a DM-RS may be defined for demodulation of the EPDCCH. An associated DM-RS may be transmitted in the EPDCCH regions 420 and 430.

An RS sequence for the associated DM-RS is equivalent to Equation 3. In this case, m=0, 1, . . . , 12N_{RB}-1, and N_{RB} is a maximum number of RBs. A pseudo-random sequence generator may be initialized as cᵢₙᵢₜ=(floor(ns/2)+1)(2N_{EPDCCH,ID}+1)2¹⁶+n_{EPDCCH,SCID} at a start of each subframe. ns is a slot number of a radio frame. N_{EPDCCH,ID} is a cell index related to a corresponding EPDCCH region. n_{EPDCCH,SCID} is a parameter given from higher layer signaling.

Each of the EPDCCH regions 420 and 430 may be used to schedule a different cell. For example, an EPDCCH in the EPDCCH region 420 may carry scheduling information for a primary cell, and an EPDCCH in the EPDCCH region 430 may carry scheduling information for a secondary cell.

When the EPDCCH is transmitted through multiple antennas in the EPDCCH regions 420 and 430, the same precoding as that used in the EPDCCH may be applied to a DM-RS in the EPDCCH regions 420 and 430.

Comparing with a case where the PDCCH uses a CCE as a transmission resource unit, a transmission resource unit for the EPDCCH is called an enhanced control channel element (ECCE). An aggregation level may be defined as a resource unit for monitoring the EPDCCH. For example, when 1 ECCE is a minimum resource for the EPDCCH, it may be defined as an aggregation level L-{1, 2, 4, 8, 16}.

A search space may corresponds to a EPDCCH region. In the search space, one or more EPDCCH candidates can be monitored in one or more aggregation level.

Now, an enhanced PHICH (EPHICH) will be described.

The legacy PHICH uses a predetermined resource in a control region of a subframe. The EPHICH may be transmitted in a data region of the subframe. The EPHICH may be detected by using blind decoding.

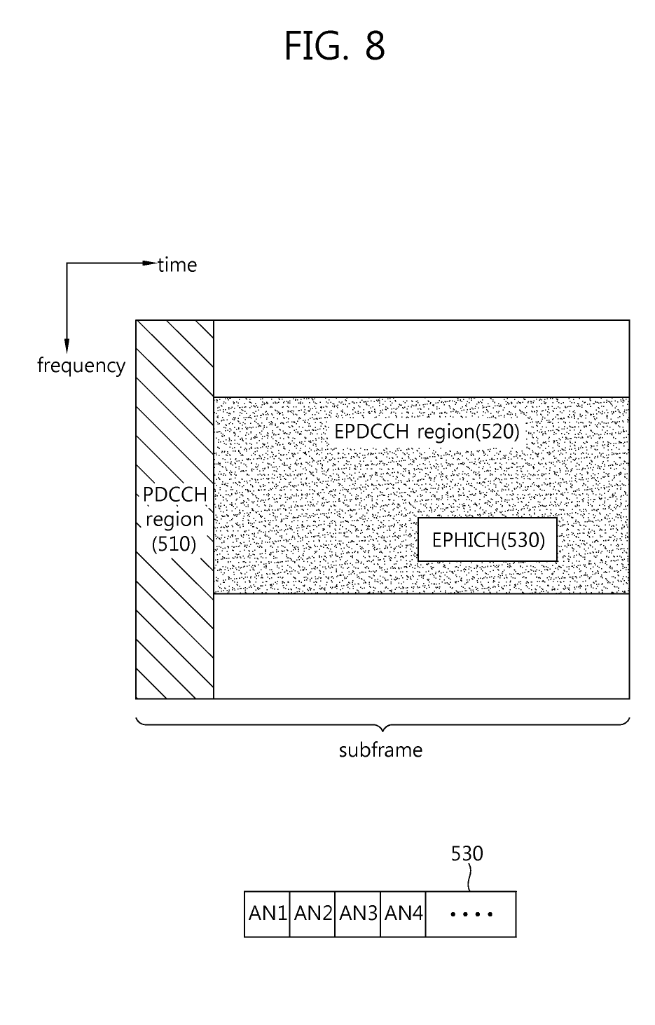

FIG. 8 shows an example of a subframe having an EPHICH according to an embodiment of the present invention.

The subframe may include zero or one PDCCH region 510 and zero or more EPDCCH regions 520. The EPDCCH region 520 is a search space for monitoring an EPDCCH, and may be a search space for monitoring an EPHICH 530.

The EPHICH 530 has a DCI format, and may include a plurality of ACK/NACK. In the figure, ‘ANx’ denotes an x^{th} ACK/NACK.

The EPDCCH region 520 may include at least any one of a common search space and a UE-specific search space. The EPHICH 530 may be monitored in the common search space and/or the UE-specific search space.

In order for the wireless device to monitor the EPHICH 530, an additional identifier (e.g., an EPHICH-RNTI) may be defined. Alternatively, a group identifier (e.g., a G-EPHICH-RNTI) may be defined for each group, and each wireless device may monitor the EPHICH 530 for a group to which it belongs.

Now, resource allocation for an EPDCCH will be described.

The EPDCCH is transmitted by using one or more ECCEs. The ECCE includes a plurality of enhanced resource element groups (EREGs). According to a CP and a subframe type based on a time division duplex (TDD) DL-UL configuration, the ECCE may include 4 EREGs or 8 EREGs. For example, the ECCE may include 4 EREGs in a normal CP case, and may include 8 EREGs in an extended CP case.

A physical resource block (PRB) pair is 2 PRBs having the same RB number in one subframe. The PRB pair is a 1^{st} PRB of a 1^{st} slot and a 2^{nd} PRB of a 2^{nd} slot in the same frequency domain. In the normal CP case, the PRB pair includes 12 subcarriers and 14 OFDM symbols, and thus includes 168 resource elements (REs).

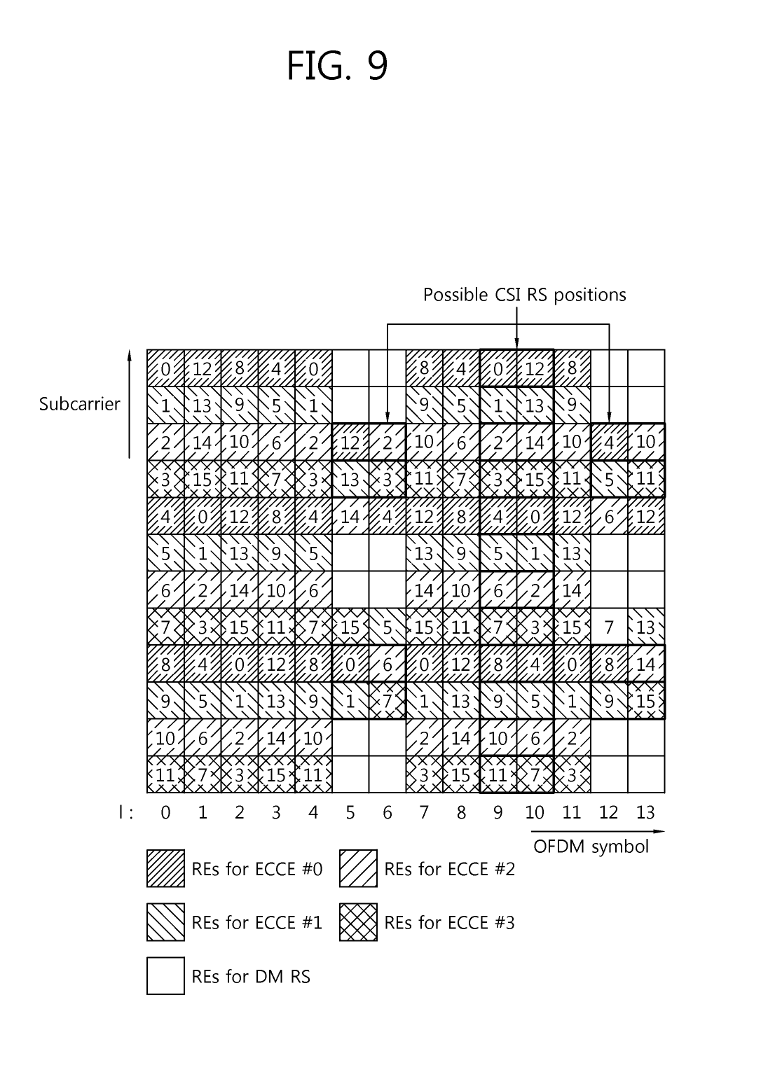

FIG. 9 shows an example of a PRB pair. Although it is assumed hereinafter that a subframe includes 2 slots and a PRB pair in one slot includes 7 OFDM symbols and 12 subcarriers, the number of OFDM symbols and the number of subcarriers are for exemplary purposes only.

In one subframe, the PRB pair includes 168 REs in total. 16 EREGs are configured from 144 REs, except for 24 REs for a DM RS. Therefore, 1 EREG may include 9 REs. However, a CRS-RS or a CRS may be placed to one PRB pair, in addition to the DM RS. In this case, the number of available REs may be decreased, and the number of REs included in 1 EREG may be decreased. The number of REs included in the EREG may be changed, whereas there is no change in the number (i.e., 16) of EREGs included in one PRB pair.

In this case, as shown in FIG. 9, an RE index may be assigned sequentially starting from a first subcarrier of a first OFDM symbol (l=0). Assume that 16 EREGs are indexed from 0 to 15. In this case, 9 REs having an RE index 0 are assigned to an EREG 0. Likewise, 9 REs corresponding to an RE index k (k=0, . . . , 15) are assigned to an EREG k.

An EREG group is defined by aggregating a plurality of EREGs. For example, if an EREG group having 4 EREGs is defined, it may be defined as an EREG group #0={EREG 0, EREG 4, EREG 8, EREG 12}, an EREG group #1={EREG 1, EREG 5, EREG 9, EREG 3}, an EREG group #2={EREG 2, EREG 6, EREG 10, EREG 14}, and an EREG group #3={EREG 3, EREG 7, EREG 11, EREG 15}. If an EREG group having 8 EREGs is defined, it may be defined as an EREG group #0={EREG 0, EREG 2, EREG 4, EREG 6, EREG 8, EREG 10, EREG 12, EREG 14} and an EREG group #1={EREG 1, EREG 3, EREG ⁵ EREG 7, EREG 9, EREG 11, EREG 13, EREG 15}.

As described above, the ECCE may include 4 EREGs. In an extended CP case, the ECCE may include 8 EREGs. The ECCE is defined by the EREG group. For example, it is exemplified in FIG. 9 that an ECCE #0 includes an EREG group #0, an ECCE #1 includes an EREG group #1, an ECCE #2 includes an EREG group #2, and an ECCE #3 includes an EREG group #3.

ECCE-to-EREG mapping has two types of transmission, i.e., localized transmission and distributed transmission. In the localized transmission, an EREG group constituting one ECCE is selected from EREGs of one PRB pair. In the distributed transmission, an EREG constituting one ECCE is selected from EREGs of different PRB pairs.

Since the number of REs belonging to the EREG may be changed as described above, the number of REs constituting the ECCE may differ for each ECCE. For example, a CSI-RS may be transmitted in OFDM symbols with 1=9, 10, and thus 2 REs are excluded in a certain ECCE, whereas 1 RE is excluded in another ECCE. As a result, the number of REs may be inconsistent between ECCEs. To reduce the inconsistency in the number of REs assigned to the ECCE, a cyclic shift of an RE index is taken into account.

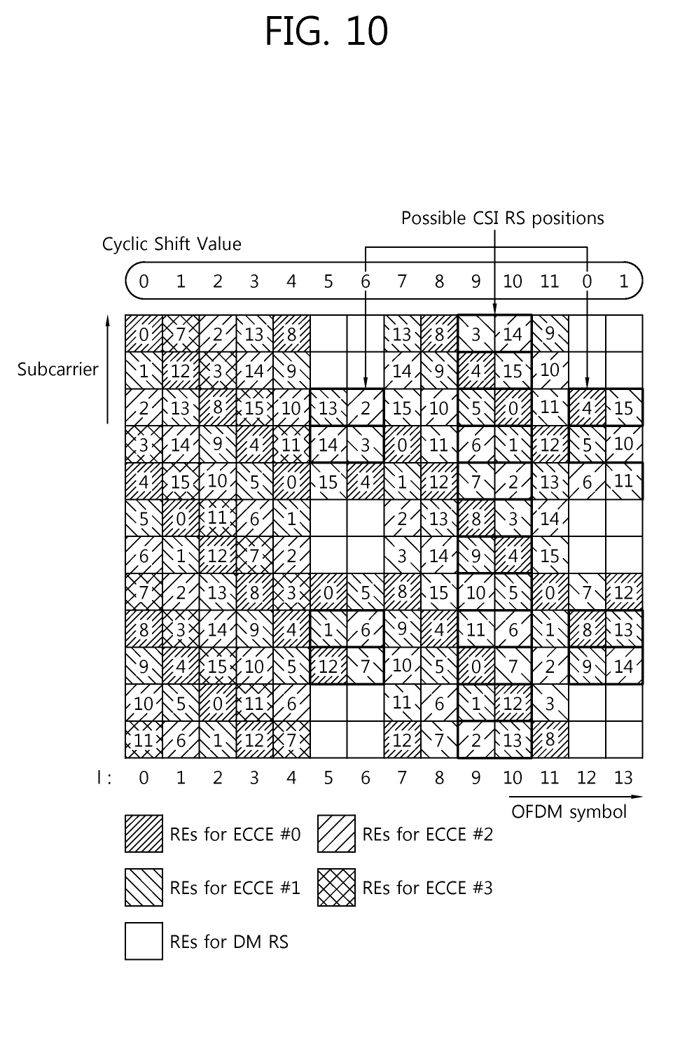

FIG. 10 shows an example of a PRB pair to which a cyclic shift is applied.

In an RE index arrangement of FIG. 10, an index of REs belonging to the same OFDM symbol is shifted by a cyclic shift value. For example, an RE index is cyclically shifted by 1 from an OFDM symbol with an index l=1, and an RE index is cyclically shifted by 2 from an OFDM symbol with an index l=2. The cyclic shift value is for exemplary purposes only.

The cyclic shift value may be given based on an OFDM symbol index.

Now, it is proposed a method by which various DL control channels such as an EPHICH and an EPDCCH can coexist in one subframe. More specifically, it is proposed a method of monitoring the EPHICH by multiplexing it to an EPDCCH region.

It is assumed hereinafter that a search space unit by which a DL control channel is monitored is divided into an ECCE, an EREG, and an RE, and an ECCE includes 8 EREGs or 4 EREGs. However, this is for exemplary purposes only. A search space may be expressed in a general term such as a 1^{st} search unit (or a 1^{st} allocation unit), a 2^{nd} search unit, and a 3^{rd} search unit.

When an EPDCCH performs decoding by using a DM RS, a DM RS overhead assumption is required. For example, in one PRB pair, 12 REs or 24 REs may be used as the DM RS. This may be predetermined by higher layer signaling, or may be requested by a wireless device by using UL feedback information. According to the UL feedback information, the DM RS overhead may be predetermined.

The EPHICH also requires a DM RS overhead assumption for EPHICH decoding if a resource region is configured in a data region similarly to the EPDCCH. For the EPHICH, the DM RS overhead may be predetermined to a specific value (e.g., 24 REs or 12 REs). The search space of the EPHICH may be designed not to be influenced by a change in an RE occupied by the DM RS. It may be assumed that the DM RS always occupies a specific RE.

Now, it is proposed a method in which a wireless device monitors an EPDCCH and an EPHICH by multiplexing the EPDCCH and the EPHICH in one search space.

Since the EPHICH includes ACK/NACK for a plurality of wireless devices, a group-RNTI may be pre-allocated to the plurality of wireless devices. Each wireless device may monitor an EPHICH candidate based on the group-RNTI. In the ACK/NACK of the EPHICH, a position of ACK/NACK of a corresponding wireless device can be known explicitly or implicitly to the wireless device on the basis of higher layer signaling, a resource of a successfully decoded EPHICH, a position or start point of a search space, etc.

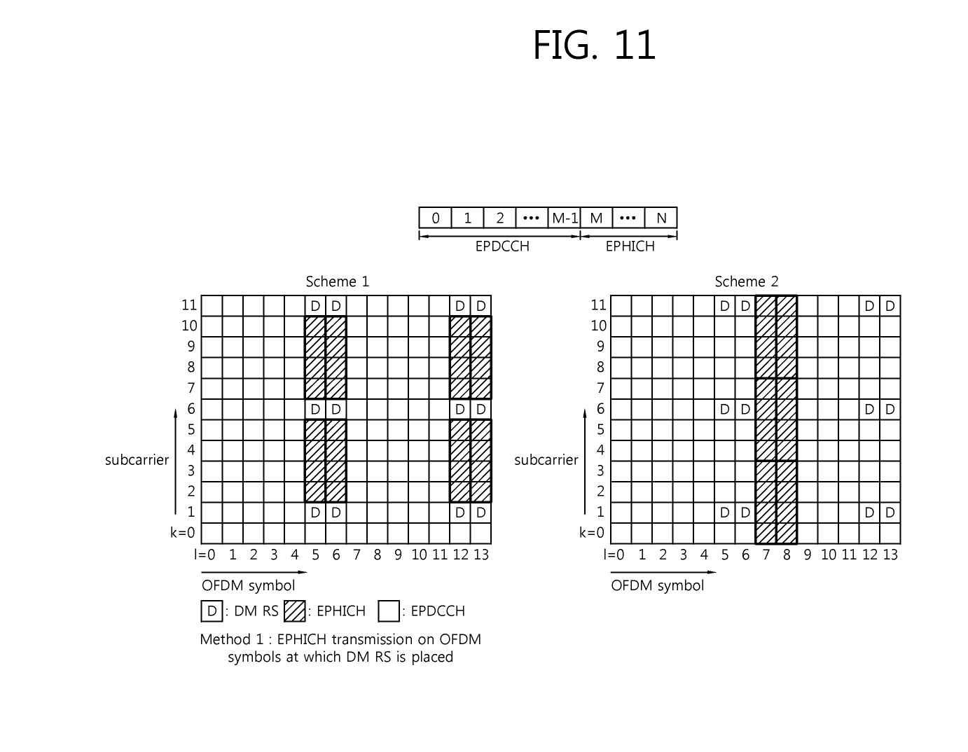

FIG. 11 shows control channel mapping according to an embodiment of the present invention.

A search space may include one or more PRB pairs. It is shown in the figure that M ECCEs are used in EPDCCH monitoring and (N-M) ECCEs are used in EPHICH monitoring under the assumption that the search space includes one PRB pair, and N ECCEs exist in one PRB pair. k denotes a subcarrier index, and I denotes an OFDM symbol index.

Positions of the EPDCCH and the EPHICH may be changed in the search space, and a channel located first between the two channels may be used as a criterion for defining an offset for a start point of the other channel.

The N ECCEs in the search space may be divided into two groups, so that a 1^{st} group is used in PDCCH monitoring and a 2^{nd} group is used in EPHICH monitoring. The ECCEs may be grouped sequentially on an index basis or may be grouped according to a specific pattern.

In addition, grouping may be performed not on an ECUE basis but on an EREG or RE basis. For example, EREGs in the search space may be divided into two groups, so that the 1^{st} group is used in PDCCH monitoring and the 2^{nd} group is used in EPHICH monitoring.

The N ECCEs may be defined as one search space, or may be divided into two search spaces. A start point, the number of channel candidates to be monitored, and an aggregation level may be configured differently for each search space. The EPDCCH is searched in a UE-specific search space, whereas the EPHICH is searched in a common search space. For example, the 1^{st} group may be designated with the UE-specific search space, and the 2^{nd} group may be designated with the common search space.

A position of a resource (or group) to which the PHICH is mapped may be predetermined or may be reported by a BS to a wireless device. Alternatively, similarly to the PHICH, a UL resource and an EPHICH resource may be associated with each other.

An encoded bit of the EPHICH may be interleaved with an encoded bit of the EPDCCH, or may be independently mapped to the ECCE (or EREG, RE).

A plurality of EPHICHs may be multiplexed to one ECCE (or EREG, RE). In this case, an index of an orthogonal sequence for orthogonal covering may be reported by the BS to the wireless device.

A subcarrier and/or OFDM symbol to which the EPHICH is mapped in the search space may be restricted. A ‘scheme 1’ shows an example of mapping the EPHICH to an OFDM symbol in which a DM RS exists, and a ‘scheme 2’ shows an example of mapping the EPHICH to an OFDM symbol in which a DM RS does not exist. A DM RS overhead may be fixed in advance to 12 REs in order to use the scheme 1 and/or the scheme 2. An ECCE or EREG restriction may be minimized due to an existence of an RE to which a DM RS is mapped (this is called a DM RS RE). According to the scheme 1, channel estimation capability of the EPHICH may be improved.

Mapping of the scheme 1 and/or the scheme 2 is also applicable to the EPDCCH. It may also be applicable to an EPDCCH which carries a specific DCI format.

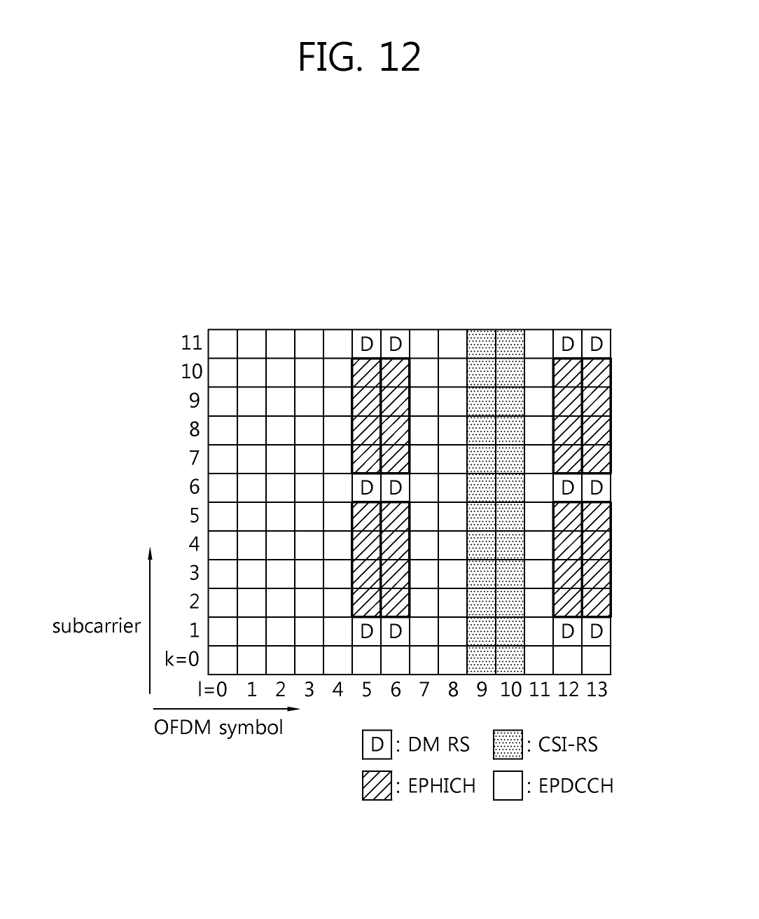

FIG. 12 shows an example of mapping an EPHICH to an OFDM symbol in which a DM RS exists.

The DM RS supports up to 2 antenna ports, and thus 12 DM RS REs exist in a PRB pair. The DM RS exists in OFDM symbols with l=5, 6, 12, 13, which is called an RS OFDM symbol. The number of DM RS REs, and the position or number of RS OFDM symbols are for exemplary purposes only.

If the EPHICH is mapped to the RS OFDM symbol, the number of DM RS REs may be fixed.

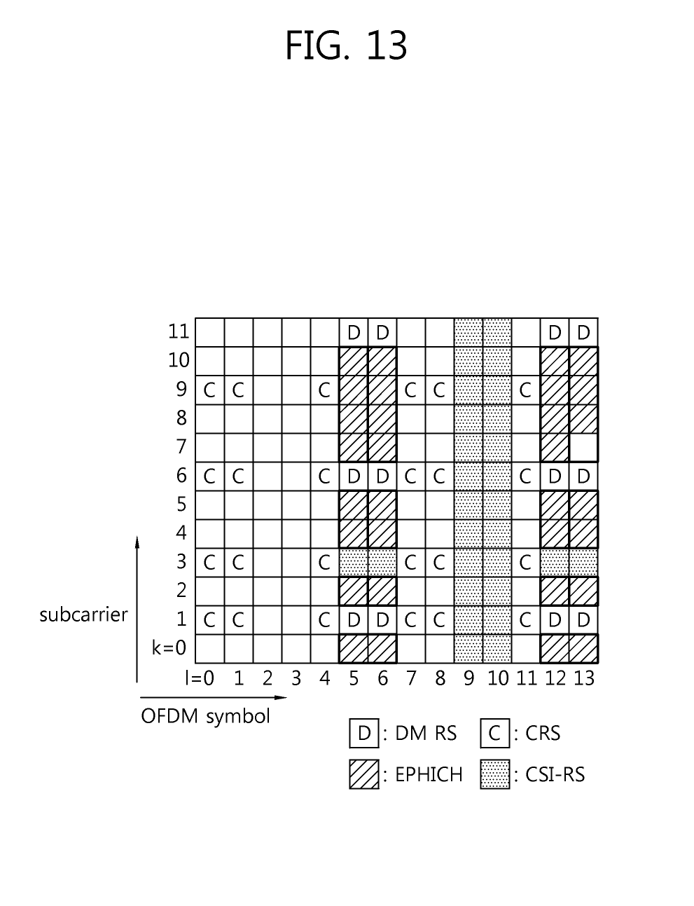

FIG. 13 shows an example in which a CRS and a CRI-RS are added in the mapping of FIG. 12.

If an EPHICH is mapped to OFDM symbols with l=5, 6, 12, 13, there is no influence of the CRS even if the CRS exist, but there may be an influence caused by the CRS-RS.

When the CRS-RS is placed to OFDM symbols with l=5, 6, 12, 13, it may be restricted such that only two antenna ports are allowed. If three or more antenna ports are used for the CSI-RS, CSI-RS transmission may not be allowed in the OFDM symbols with l=5, 6, 12, 13. Alternatively, if three or more antenna ports are used for the CSI-RS, it may be restricted such that CSI-RS transmission is transmitted only in OFDM symbols with l=9, 10.

Mapping of FIG. 12 may be used in a subframe in which the CSI-RS does not exist, and mapping of FIG. 13 may be used in a subframe in which the CSI-RS exists.

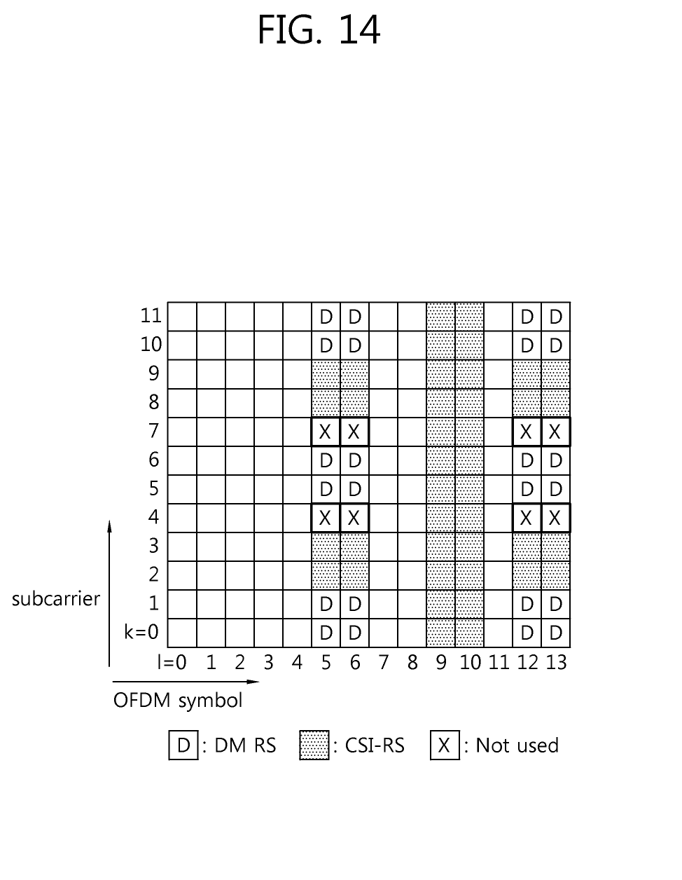

FIG. 14 shows an example of mapping a DM RS and a CSI-RS.

If 24 DM RS REs exist in a PRB pair and the number of antenna ports of the CRI-RS is greater than or equal to 4, the number of REs for mapping an EPHICH to an RS OFDM symbol is insufficient. Therefore, the EPHICH is not mapped to the RS OFDM symbol.

If a DM RS overhead is greater than or equal to a specific level, the wireless device may not expect that the EPHICH is transmitted in the RS OFDM symbol, and may not monitor the EPHICH. For example, the wireless device knows that 24 REs are configured with the DM RS, and 8 antenna ports are configured for the CSI-RS, and thus the EPHICH may not be monitored in a corresponding subframe.

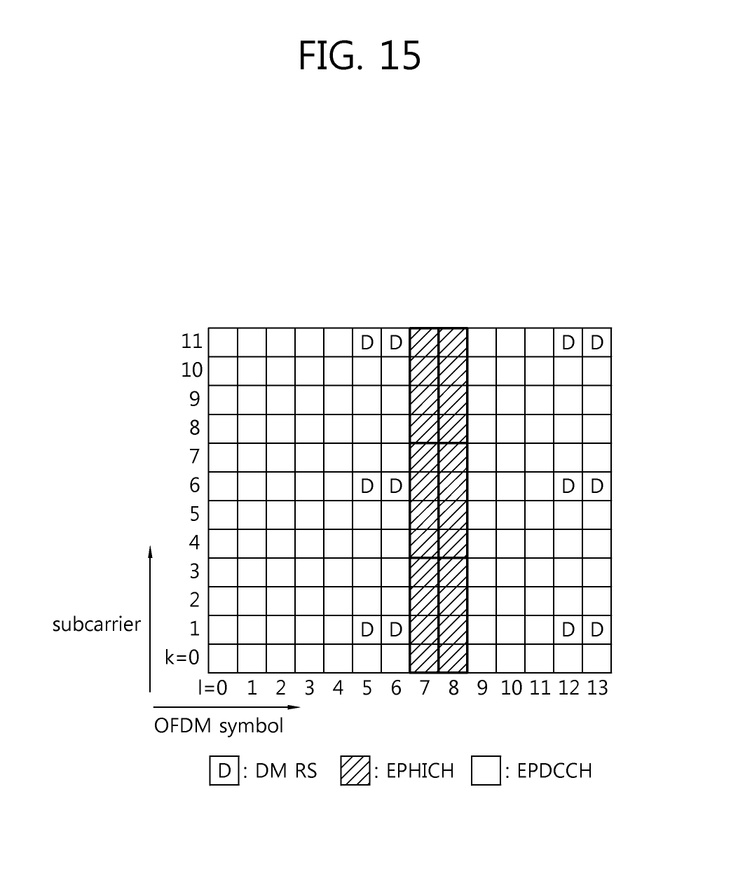

FIG. 15 shows an example of mapping an EPHICH to an OFDM symbol in which a DM RS does not exist.

The DM RS does not exist in OFDM symbols with l=7, 8. This is called a non-RS OFDM symbol. If each non-RS OFDM symbol has 12 REs and an EREG includes 4 REs, 3 EREGs may exist. Repetition can be performed 3 times by using a spreading factor 4, and 16 EPHICHs may be transmitted across 2 OFDM symbols.

If the EPHICH cannot be mapped to the RS OFDM symbol according to the mapping of FIG. 14, the mapping of FIG. 15 may be used.

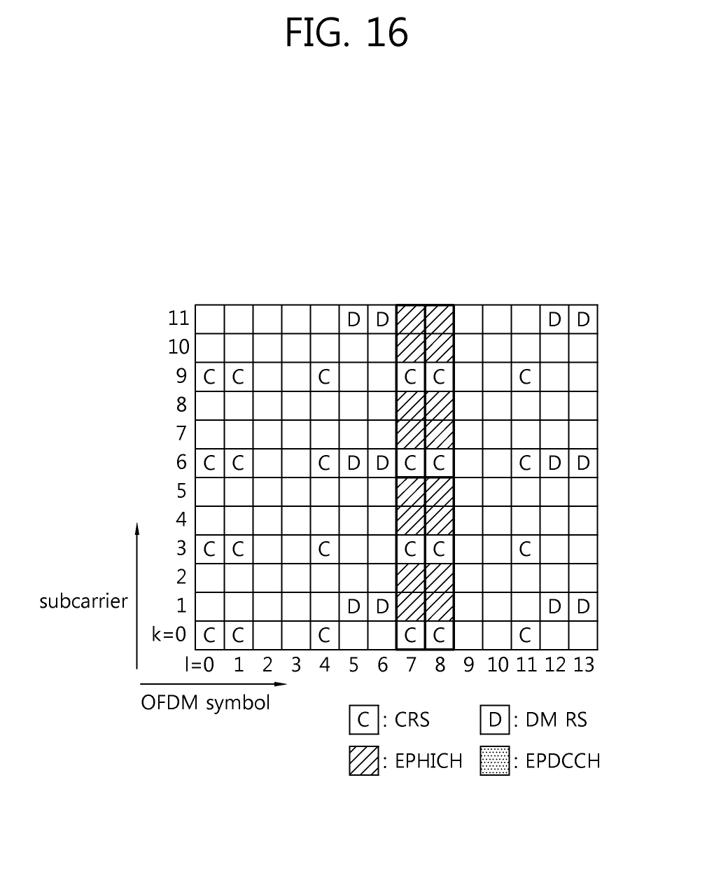

FIG. 16 shows an example in which a CRS is added in the mapping of FIG. 15.

The CRS exists, and 2 EREGs may exist in one non-RS OFDM symbol. Repetition can be performed 2 times by using a spreading factor 4, and 8 EPHICHs may be transmitted across 2 OFDM symbols.

Now, it is proposed a method in which a BS multiplexes and transmits a DL control channel (e.g., an EPDCCH and an EPHICH) in a search space consisting of a PRB pair, and a wireless device monitors the DL control channel.

First, a transmission/monitoring method applicable to the control channel may be divided into three schemes as follows.

According to a ‘localized non-interleaved scheme’, search spaces of different wireless devices are not deployed together in a PRB pair, and the PRB pair is not distributed in a frequency domain. In one search space, only a DL control channel for one wireless device is monitored.

Control information for a specific wireless device is not spread to several PRBs. If 4 ECCEs are defined in one PRB pair, up to an aggregation level 4 may exist in one PRB pair. However, an aggregation level 8 exists in 2 PRB pairs. In this case, the 2 PRB pairs may be contiguous in a frequency domain, or may not be contiguous.

According to a ‘distributed non-interleaved scheme’, search spaces of different wireless devices are not deployed together in a PRB pair, and the PRB pair is distributed in a frequency domain. One ECCE may include a plurality of EREGs, and each EREG may be deployed in a distributed manner in a plurality of PRB pairs. In one search space, only a DL control channel for one wireless device is monitored.

According to a ‘distributed interleaved scheme’, DL control channels of different wireless devices may be multiplexed in one search space. One ECCE may include a plurality of EREGs, and each EREG may be deployed in a distributed manner in a plurality of PRB pairs.

A search space for monitoring a DL control channel may be constructed of K groups, and each group may include N PRB pairs. For example, if K=2, N=4, then 2 EPHICH monitoring groups exist, and each monitoring group may include 4 PRB pairs. The values K and N may be determined by a BS, and may be increased when the number of serving cells is increased.

The aforementioned three transmission schemes may operate respectively in distinctive PRB units. However, it is also possible that the three transmission schemes coexist in a PRB pair.

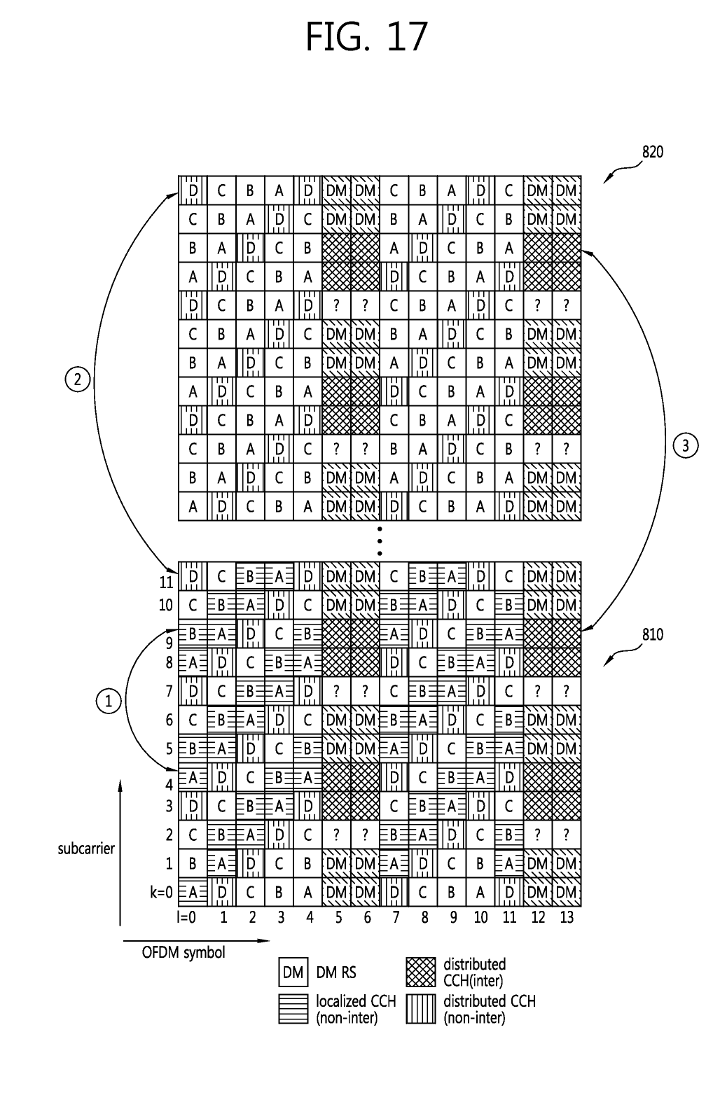

FIG. 17 shows an example in which three transmission schemes coexist.

‘1’ denotes a localized non-interleaving scheme, ‘2’ denotes a ‘distributed non-interleaving scheme, and ‘3’ denotes a ‘distributed interleaving scheme’. ‘A’, ‘B’, ‘C’, and ‘D’ denote an RE for a corresponding control channel. Instead of the RE, another unit may also be used such as an EREG or an ECCE.

According to the localized non-interleaving scheme, a DL control channel is mapped to ‘A’ and ‘B’ of a 1^{st} PRB pair 810.

According to the distributed non-interleaving scheme, a DL control channel is mapped to ‘D’ of the 1^{st} PRB pair 810 and ‘B’ of a 2^{nd} PRB pair 820.

In order to use all of the three transmission schemes in one PRB pair and to use a diversity scheme such as space frequency block code (SFBC), at least two antenna ports are required. Accordingly, a 12RE DM RS overhead may be assumed. If the three transmission schemes are not all used in one subframe, a 12RE overhead may be assumed. Alternatively, the 24RE overhead may be assumed when using the distributed interleaving scheme, and the 12RE overhead may be assumed when the distributed interleaving scheme is not used. This has an advantage in that additional signaling for the DM RS overhead is not required.

Alternatively, the 24RE overhead may be assumed in a search space in which the distributed interleaving scheme is used, or the 12RE overhead or 24RE overhead may be assumed in a search space in which the distributed interleaving scheme is not used.

Now, a method for supporting a high order modulation (HOM) for a DL control channel will be described. The HOM implies that a modulation scheme is applied with a modulation order 4 or higher (e.g., 16-QAM, 64-QAM, etc.).

When a control channel and a DM RS are deployed to one OFDM symbol, power of the control channel may be decreased, which may make it difficult to support the HOM.

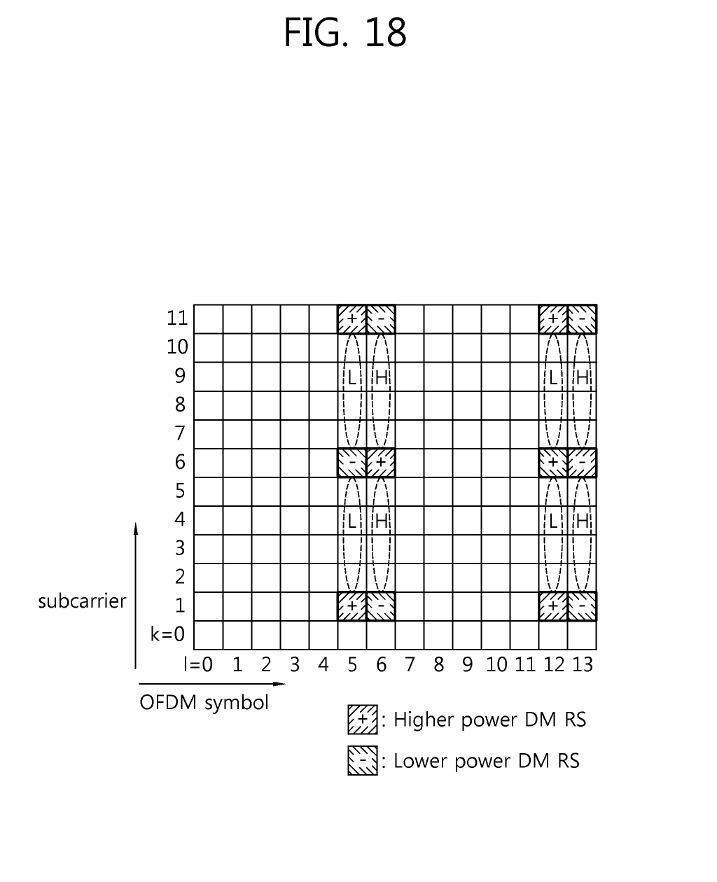

FIG. 18 shows a power loss caused by a DM RS.

Due to high transmission power of a DM RS RE, transmission power of the remaining REs may be relatively low in a corresponding OFDM symbol.

For example, it is assumed that a DM RS RE of OFDM symbols with 1=5, 12 has high transmission power, and a DM RS RE of OFDM symbols with l=6, 13 has relatively low transmission power. Accordingly, transmission power allocated to a control channel mapped to the remaining REs of the OFDM symbols with l=5, 12 is lower than that of OFDM symbols with l=6, 13. Since power cannot be sufficiently allocated to the control channel while great power is allocated to the DM RS, it may be difficult to correctly monitor the control channel.

For this, it is proposed to regulate transmission power for each RE by applying spreading (or orthogonal covering).

If it is assumed that [1, −1] is expressed by [+, −], the number of symbols ‘+’ and the number of symbols ‘−’ may be kept equally or similarly in the same OFDM symbol.

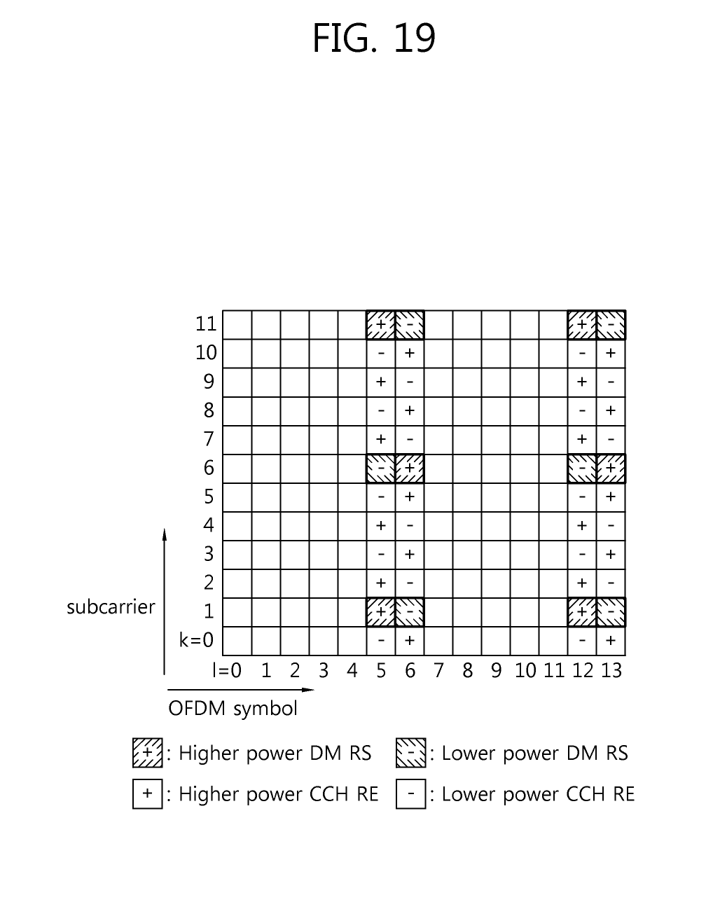

FIG. 19 shows an example of spreading a control channel for a DM RS which uses 2 antenna ports.

A DM RS RE and a control channel RE exist in one RS OFDM symbol, and ‘1’ and ‘−1’ are equally distributed by 6 REs across 12 REs in total. Accordingly, a power shortage problem in a specific OFDM symbol may be solved.

A ratio of the DM RS RE to the control channel RE may be designed with a greater margin, such as 7:5, instead of 6:6, according to power distribution.

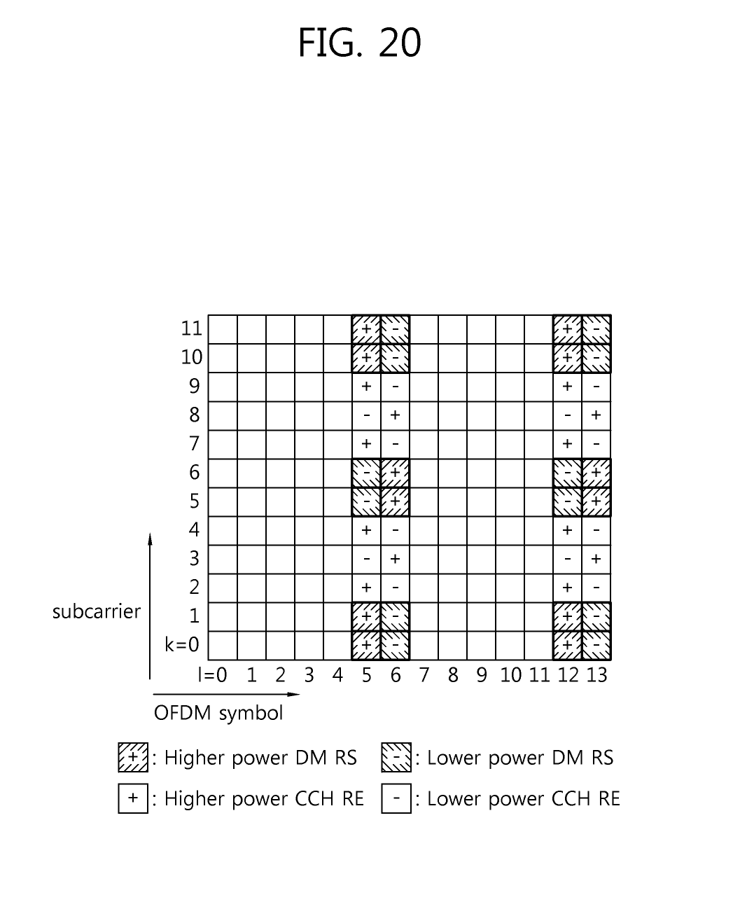

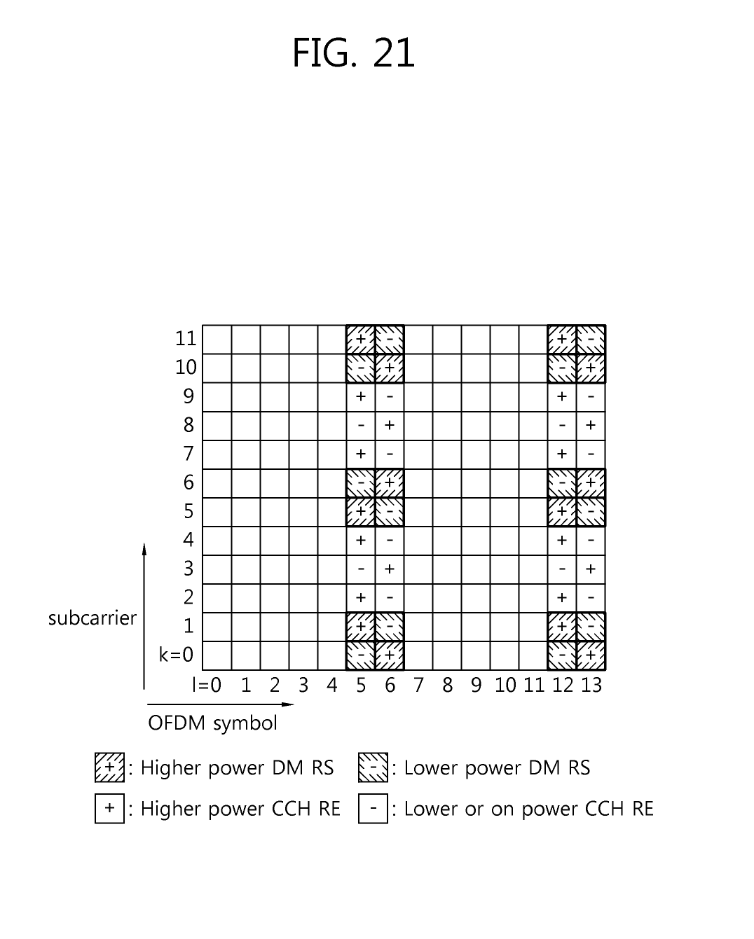

FIG. 20 and FIG. 21 show an example of spreading a control channel for a DM RS which uses 4 antenna ports. Since the spreading of the DM RS changes, various types of spreading may be applied to regulate transmission power of the control channel.

As another embodiment of solving the transmission power shortage, in a specific RE, a CCH may not be mapped or transmission power may be set to 0.

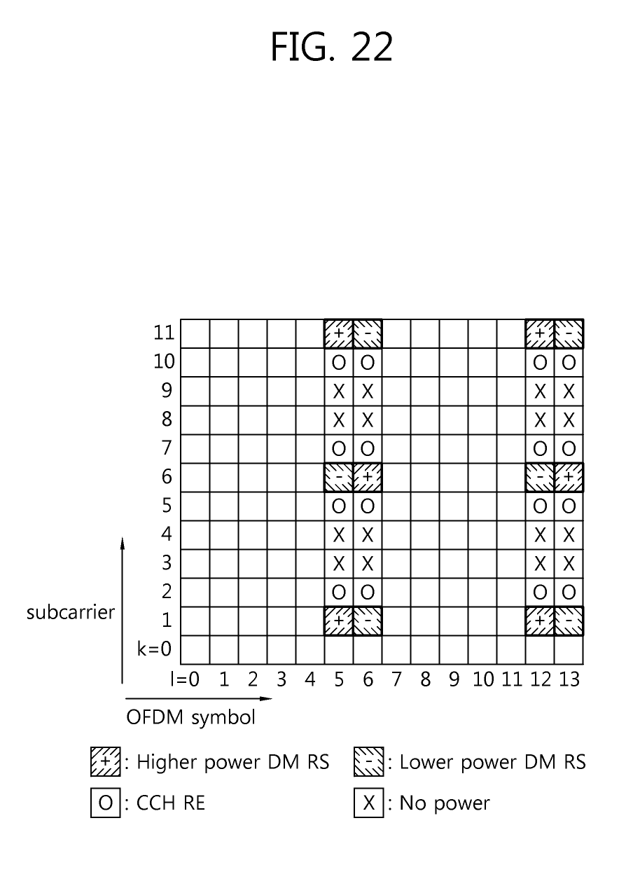

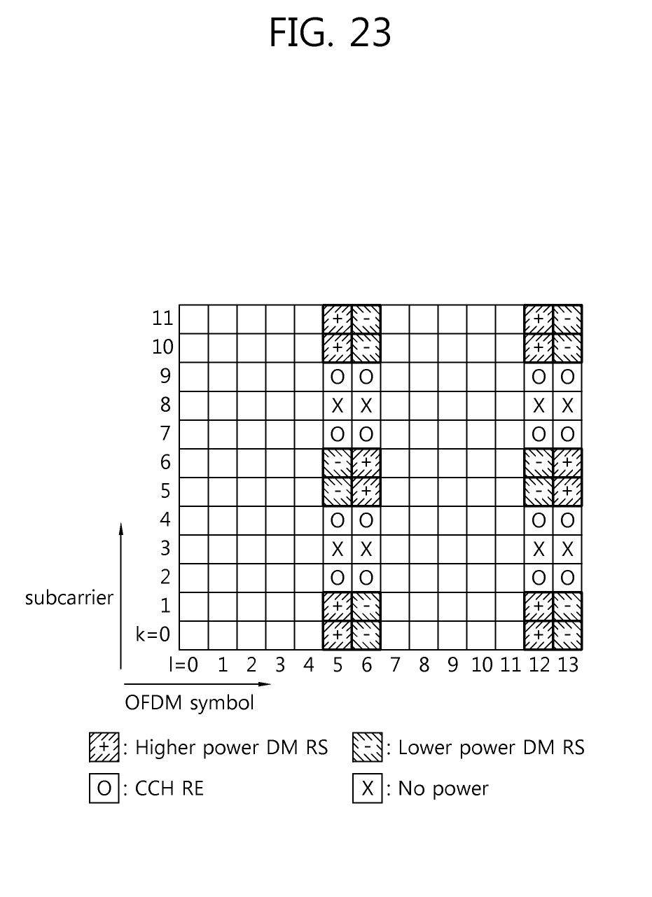

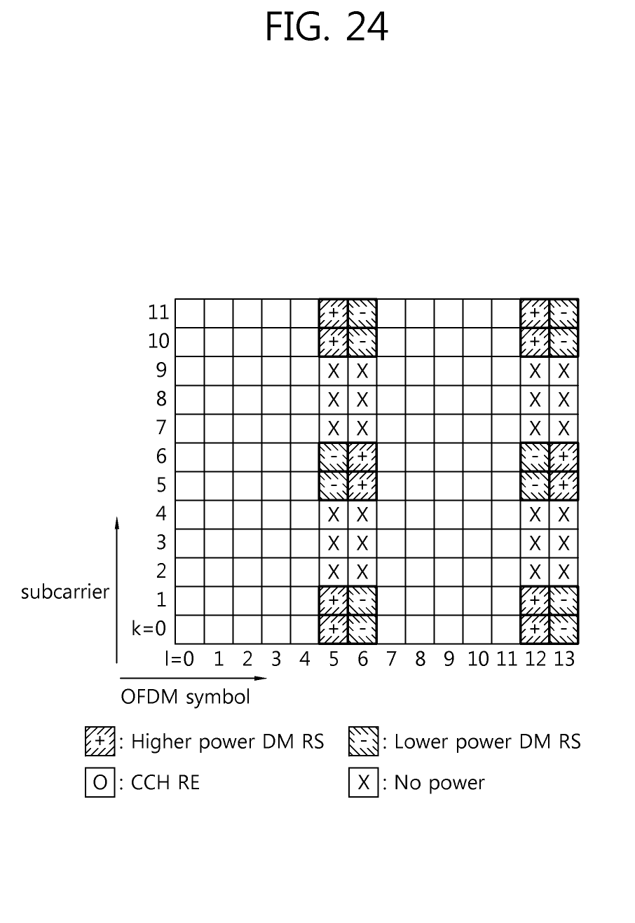

FIG. 22, FIG. 23, and FIG. 24 show another example of spreading a control channel for a DM RS.

Some of 4 REs existing between DM RSs in one RS OFDM symbol are not used. Unused REs are REs located far from the DM RS. That is, an RE of which a channel estimation error may be great is not used as much as possible. Alternatively, as shown in FIG. 24, all of the remaining REs other than the DM RS RE may not be used in the RS OFDM symbol.

According to how to configure the DM RS, energy (or a power ratio) between the DM RS RE and a control channel (CCH) RE may be reported by a BS to a UE. This is because a modulation criterion of a corresponding symbol may vary depending on a case where the DM RS exists and a case where the DM RS does not exist.

The aforementioned method shows excellent performance in the following combinations.

Combination 1. HOM EPDCCH+QPSK EPHICH

Combination 2. HOM EPDCCH+QPSK EPDCCH+QPSK EPHICH

Combination 3. QPSK EPDCCH+QPSK EPHICH

The combination 1 has no problem since an EPHICH corresponds to QPSK having a constant amplitude property. However, an EPDCCH capable of having 16-QAM and 64-QAM requires a correct reference energy value and signal energy value. This is because information is carried on an amplitude on a constellation.

The combination 2 is a case where a HOM EPDCCH and a QPSK EPDCCH coexist. The HOM EPDCCH may not be mapped to an RS OFDM symbol. Alternatively, the QPSK EPDCCH may be mapped only to the RS OFDM symbol. This is because demodulation of QPSK is relatively less influenced by a presence/absence of the DM RS.

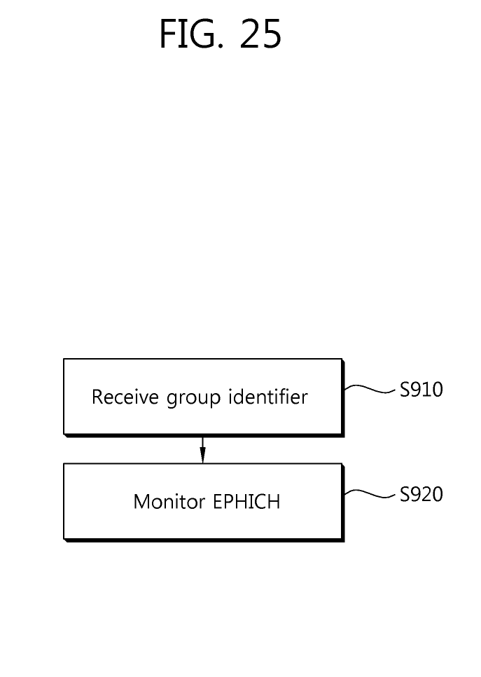

FIG. 25 shows control channel monitoring according to an embodiment of the present invention.

In step S910, a wireless device receives information regarding a group identifier (or group RNTI) to be used in monitoring of an EPHICH from a BS. The group identifier indicates a device group for receiving ACK/NACK information to be included in the EPHICH. The ACK/NACK information may include ACK/NACK for one or more wireless devices.

In step S920, the wireless device may monitor an EPHICH and/or an EPDCCH in a search space. If decoding of the EPHICH is successful on the basis of the group identifier, the wireless device may extract its ACK/NACK from the ACK/NACK information on the EPHCIH.

Resource mapping of the EPHICH and the EPDCCH in the search space may be performed according to at least any one of the aforementioned mapping examples of FIG. 11 to FIG. 25.

The EPHICH resource may be defined based on an ECCE or EREG defined for the EPDCCH. The EPHICH may be monitored in a search space of the EPDCCH. The

EPHICH may be monitored in one or more PRB pairs. The EPHICH may be monitored only in a 1^{st} slot or a 2^{nd} slot.

A spreading factor of the EPHICH may be in proportion to an EREG size. If the EREG includes k REs, a spreading sequence size of the EPHICH may vary depending on k.

The EPHICH may support localized transmission and distributed transmission of the EPDCCH. Alternatively, the EPHIDCH may support the localized transmission or the distributed transmission. For example, if the EPHICH supports only the distributed transmission, the EPHICH may be monitored only when the EPDCCH is configured to the distributed transmission, and the EPHICH may not be monitored if the EPDCCH is configured to the localized transmission.

The EPHICH may be mapped only to the EREG including the minimum number of required REs. For example, the EPHICH may be mapped only to an EREG including 8 or more REs.

Monitoring of the EPHICH may depend on monitoring of a corresponding EPDCCH. If a monitoring configuration (e.g., a search space, an aggregation level, the number of candidates) of the EPDCCH is changed, a monitoring configuration of the EPHICH may also be changed.

An EPHICH resource may be defined as an EREG of a specific index or a specific antenna port. The EPHICH may be monitored in a specific EREG (or a specific ECCE, a specific PRB pair).

Information for monitoring the EPHICH may be transmitted by using system information or an RRC message. The information may include information on a subframe or PRB pair in which the EPHICH is to be monitored and/or a search space of the EPHICH.

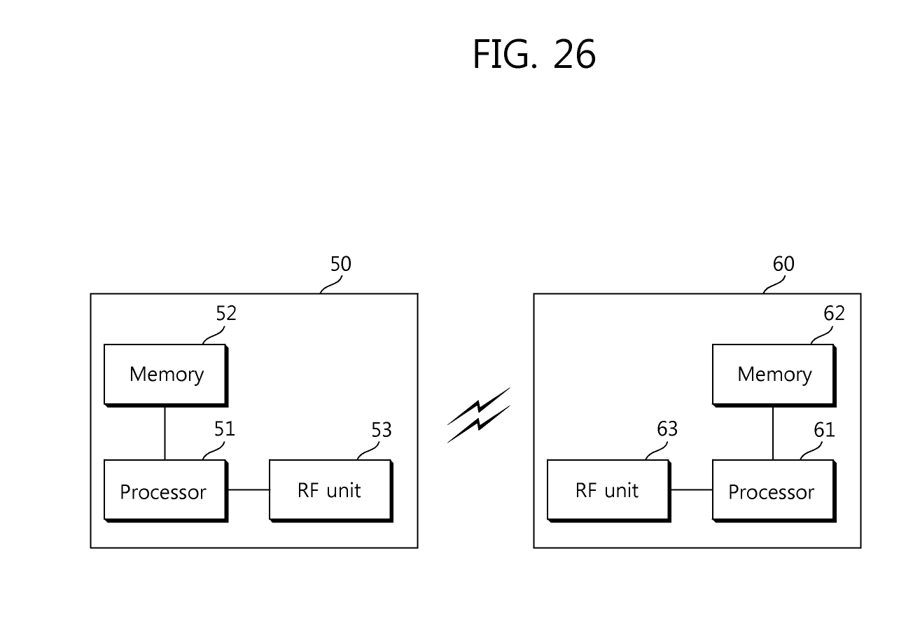

FIG. 26 is a block diagram showing a wireless communication system according to an embodiment of the present invention.

A BS 50 includes a processor 51, a memory 52, and a radio frequency (RF) unit 53. The memory 52 is coupled to the processor 51, and stores a variety of information for driving the processor 51. The RF unit 53 is coupled to the processor 51, and transmits and/or receives a radio signal. The processor 51 implements the proposed functions, procedures, and/or methods. In the aforementioned embodiment, an operation of the BS may be implemented by the processor 51. The processor 51 may configure a search space for an EPDCCH and/or an EPHICH, and may transmit the EPDCCH and the EPHICH.

A wireless device 60 includes a processor 61, a memory 62, and an RF unit 63. The memory 62 is coupled to the processor 61, and stores a variety of information for driving the processor 61. The RF unit 63 is coupled to the processor 61, and transmits and/or receives a radio signal. The processor 61 implements the proposed functions, procedures, and/or methods. In the aforementioned embodiment, an operation of the wireless device may be implemented by the processor 60. The processor 61 may monitor the EPDCCH and the EPHICH in a search space.

The processor may include Application-Specific Integrated Circuits (ASICs), other chipsets, logic circuits, and/or data processors. The memory may include Read-Only Memory (ROM), Random Access Memory (RAM), flash memory, memory cards, storage media and/or other storage devices. The RF unit may include a baseband circuit for processing a radio signal. When the above-described embodiment is implemented in software, the above-described scheme may be implemented using a module (process or function) which performs the above function. The module may be stored in the memory and executed by the processor. The memory may be disposed to the processor internally or externally and connected to the processor using a variety of well-known means.

In the above exemplary systems, although the methods have been described on the basis of the flowcharts using a series of the steps or blocks, the present invention is not limited to the sequence of the steps, and some of the steps may be performed at different sequences from the remaining steps or may be performed simultaneously with the remaining steps. Furthermore, those skilled in the art will understand that the steps shown in the flowcharts are not exclusive and may include other steps or one or more steps of the flowcharts may be deleted without affecting the scope of the present invention.

What is claimed is:

1. A method for monitoring a control channel in a wireless communication system, the method comprising:
receiving, by a wireless device, a group identifier from a base station; and
monitoring, by the wireless device, a downlink control channel in a search space including N (N>=1) enhanced control channel elements (ECCEs) in accordance with the group identifier,
wherein the downlink control channel includes positive-acknowledgement (ACK)/negative-acknowledgement (NACK) information having hybrid automatic repeat request (HARQ) ACK/NACK for at least one wireless device.

2. The method of claim 1, wherein the N ECCEs are defined in one or more physical resource block (PRB) pairs.

3. The method of claim 1, wherein the downlink control channel is monitored in M (M<N) ECCEs among the N ECCEs, and a different downlink control channel is monitored in the remaining ECCEs.

4. The method of claim 3, wherein the downlink control channel is an enhanced physical HARQ indicator channel (EPHICH), and the different downlink control channel is an enhanced physical downlink control channel (EPDCCH).

5. The method of claim 3,
wherein each ECCE includes at least one enhanced resource element group (EREG), and each EREG includes at least one resource element (RE), and
wherein the number of REs included in each EREG is changeable according to a configuration of a reference signal used in demodulation of the downlink control channel.

6. The method of claim 5, wherein the downlink control channel is monitored in an ECCE having an EREG including a minimum number of REs.

7. A wireless device for monitoring a control channel in a wireless communication system, the wireless device comprising:
a radio frequency (RF) unit configured to transmit and receive a radio signal; and
a processor operatively coupled to the RF unit and configured to:
receive a group identifier from a base station; and
monitor a downlink control channel in a search space including N(N>=1) enhanced control channel elements (ECCEs) in accordance with the group identifier,
wherein the downlink control channel includes positive-acknowledgement (ACK)/negative-acknowledgement (NACK) information having hybrid automatic repeat request (HARQ) ACK/NACK for at least one wireless device.

8. The wireless device of claim 7, wherein the N ECCEs are defined in one or more physical resource block (PRB) pairs.

9. The wireless device of claim 7, wherein the downlink control channel is monitored in M (M<N) ECCEs among the N ECCEs, and a different downlink control channel is monitored in the remaining ECCEs.
